(19) United States
(12) Patent Application Publication
(10) Pub. No.: US 2025/0224600 A1
(43) Pub. Date: Jul. 10, 2025

(54) STEREOSCOPIC OPTICAL SYSTEM AND IMAGE PICKUP APPARATUS

(71) Applicant: CANON KABUSHIKI KAISHA, Tokyo (JP)

(72) Inventors: Maki YOKOYA, Tochigi (JP); Koji AOKI, Saitama (JP)

(21) Appl. No.: 18/964,997

(22) Filed: Dec. 2, 2024

(30) Foreign Application Priority Data
Jan. 5, 2024 (JP) 2024-000756
Jan. 5, 2024 (JP) 2024-000777

(51) Int. Cl. G02B 15/14; G02B 15/16; G03B 35/08

(52) U.S. Cl. CPC G02B 15/144113; G02B 15/145113; G02B 15/16; G03B 35/08

(57) ABSTRACT

A stereoscopic optical system includes two optical systems configured to perform magnification variation and arranged in parallel. Each optical system includes, in order from an object side to an image side, a first lens unit having positive refractive power, a second lens unit having negative refractive power, a third lens unit, and a rear group including a fourth lens unit and having positive refractive power as a whole. A distance between adjacent lens units changes during magnification variation. The third lens unit includes a first reflective surface, a second reflective surface, and an aperture stop, and a distance between optical axes between rear groups in the two optical systems is narrower than a distance between optical axes of the first lens units in the two optical systems due to bending of an optical path by the first reflective surface and the second reflective surface. A predetermined inequality is satisfied.

### BACKGROUND

### Technical Field

The present disclosure relates to a stereoscopic optical system for three-dimensional imaging.

### Description of Related Art

For three-dimensional imaging, a stereoscopic optical system including two optical systems arranged in parallel is used, as disclosed in Japanese Patent Laid-Open No. 2023-074578 and the like.

### SUMMARY

A stereoscopic optical system according to one aspect of the disclosure includes two optical systems configured to perform magnification variation and arranged in parallel. Each of the two optical systems includes, in order from an object side to an image side, a first lens unit having positive refractive power, a second lens unit having negative refractive power, a third lens unit, and a rear group including a fourth lens unit and having positive refractive power as a whole. A distance between adjacent lens units changes during magnification variation. The third lens unit includes a first reflective surface, a second reflective surface, and an aperture stop, and a distance between optical axes between rear groups in the two optical systems is narrower than a distance between optical axes of the first lens units in the two optical systems due to bending of an optical path by the first reflective surface and the second reflective surface. The following inequality is satisfied:

$$0.16 \leq \vert m 4 / f 4 \vert \leq 1.28$$

where m4 is a moving amount of the fourth lens unit during magnification variation from a wide-angle end to a telephoto end, and f4 is a focal length of the fourth lens unit.

A stereoscopic optical system according to another aspect of the disclosure includes two optical systems configured to perform magnification variation and arranged in parallel. Each of the two optical systems includes, in order from an object side to an image side, a first lens unit having positive refractive power, a second lens unit having negative refractive power, a third lens unit, and a rear group including at least one lens unit. A distance between adjacent lens units changes during magnification variation. The third lens unit has a first reflective surface and a second reflective surface, and a distance between optical axes between rear groups in the two optical systems is narrower than a distance between optical axes of the first lens units in the two optical systems due to bending of an optical path by the first reflective surface and the second reflective surface. In each of the two optical systems, at least the second lens unit moves during magnification variation. The following inequality is satisfied:

$$3.5 \leq f 1 / fw \leq 32.$$

where fw is a focal length of each of the two optical systems at a wide-angle end, and f1 is a focal length of the first lens unit.

An image pickup apparatus having the above stereoscopic optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1A is a sectional view of a stereoscopic optical system according to Example 1 at a wide-angle end.

FIGS. 1B and 1C are longitudinal aberration diagrams of the stereoscopic optical system according to Example 1 at a wide-angle end and a telephoto end, respectively.

FIG. 2A is a sectional view of a stereoscopic optical system according to Example 2 at a wide-angle end.

FIGS. 2B and 2C are longitudinal aberration diagrams of the stereoscopic optical system according to Example 2 at a wide-angle end and a telephoto end, respectively.

FIG. 3A is a sectional view of a stereoscopic optical system according to Example 3 at a wide-angle end.

FIGS. 3B and 3C are longitudinal aberration diagrams of the stereoscopic optical system according to Example 3 at a wide-angle end and a telephoto end, respectively.

FIG. 4A is a sectional view of a stereoscopic optical system according to Example 4 at a wide-angle end.

FIGS. 4B and 4C are longitudinal aberration diagrams of the stereoscopic optical system according to Example 4 at a wide-angle end and a telephoto end, respectively.

FIG. 5A is a sectional view of a stereoscopic optical system according to Example 5 at a wide-angle end.

FIGS. 5B and 5C are longitudinal aberration diagrams of the stereoscopic optical system according to Example 5 at a wide-angle end and a telephoto end, respectively.

FIG. 6A is a sectional view of a stereoscopic optical system according to Example 6 at a wide-angle end.

FIGS. 6B and 6C are longitudinal aberration diagrams of the stereoscopic optical system according to Example 6 at a wide-angle end and a telephoto end, respectively.

FIG. 7 illustrates a top view of each of the stereoscopic optical systems according to each of Examples 1 to 6.

FIG. 8 illustrates a schematic diagram of two image circles formed by the stereoscopic optical system according to each of Examples 1 to 6.

FIG. 9 is a sectional view of a stereoscopic optical system according to Example 7.

FIG. 10 is a longitudinal aberration diagram of the stereoscopic optical system according to Example 7 at a wide angle in an in-focus state at infinity.

FIG. 11 is a longitudinal aberration diagram of the stereoscopic optical system according to Example 7 at a wide angle in an in-focus state at a close distance.

FIG. 12 is a longitudinal aberration diagram of the stereoscopic optical system according to Example 7 at a telephoto end in an in-focus state at infinity.

FIG. 13 is a longitudinal aberration diagram of the stereoscopic optical system according to Example 7 at a telephoto end in an in-focus state at a close distance.

FIG. 14 is a sectional view of a stereoscopic optical system according to Example 8.

FIG. 15 is a longitudinal aberration diagram of the stereoscopic optical system according to Example 8 at a wide angle in an in-focus state at infinity.

FIG. 16 is a longitudinal aberration diagram of the stereoscopic optical system according to Example 8 at a wide angle in an in-focus state at a close distance.

FIG. 17 is a longitudinal aberration diagram of the stereoscopic optical system according to Example 8 at a telephoto end in an in-focus state at infinity.

FIG. 18 is a longitudinal aberration diagram of the stereoscopic optical system according to Example 8 at a telephoto end in an in-focus state at a close distance.

FIG. 19 is a sectional view of a stereoscopic optical system according to Example 9.

FIG. 20 is a longitudinal aberration diagram of the stereoscopic optical system according to Example 9 at a wide-angle end in an in-focus state at infinity.

FIG. 21 is a longitudinal aberration diagram of the stereoscopic optical system according to Example 9 at a wide-angle end in an in-focus state at a close distance.

FIG. 22 is a longitudinal aberration diagram of the stereoscopic optical system according to Example 9 at a telephoto end in an in-focus state at infinity.

FIG. 23 is a longitudinal aberration diagram of the stereoscopic optical system according to Example 9 at a telephoto end in an in-focus state at a close distance.

FIG. 24 is a sectional view of a stereoscopic optical system according to Example 10.

FIG. 25 is a longitudinal aberration diagram of the stereoscopic optical system according to Example 10 at a wide angle in an in-focus state at infinity.

FIG. 26 is a longitudinal aberration diagram of the stereoscopic optical system according to Example 10 at a wide angle in an in-focus state at a close distance.

FIG. 27 is a longitudinal aberration diagram of the stereoscopic optical system according to Example 10 at a telephoto end in an in-focus state at infinity.

FIG. 28 is a longitudinal aberration diagram of the stereoscopic optical system according to Example 10 at a telephoto end in an in-focus state at a close distance.

FIG. 29 is a top view of each of the stereoscopic optical systems according to Examples 7 to 10.

FIG. 30 is a schematic diagram of image circles formed by the stereoscopic optical system according to each of Examples 7 to 10.

FIG. 31 is a schematic diagram of an image pickup apparatus including the stereoscopic optical system according to any one of Examples 1 to 10.

### DETAILED DESCRIPTION

Referring now to the accompanying drawings, a detailed description will be given of embodiments according to the disclosure. The embodiment described below is an example of a means for realizing the present disclosure, and may be modified or changed as appropriate depending on the configuration of an apparatus to which the present disclosure is applied and a variety of conditions. In addition, each embodiment can be combined as appropriate.

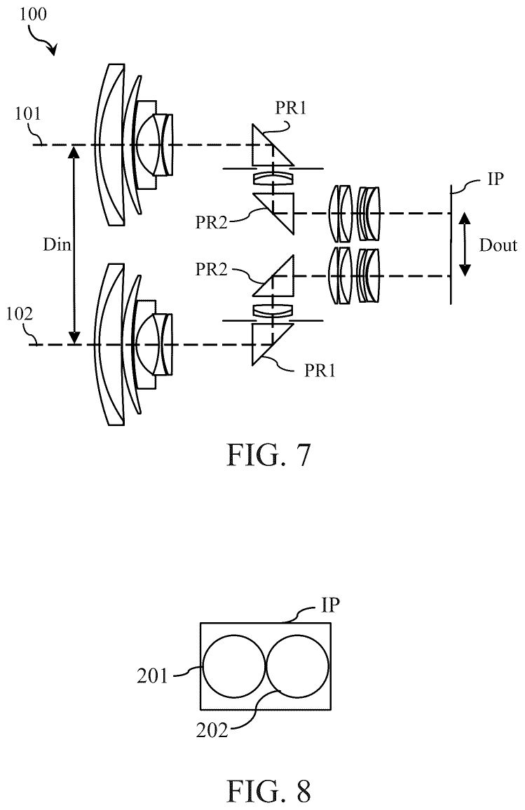

FIG. 7 illustrates the basic configuration of a stereoscopic optical system 100 according to each of Examples 1 to 6 viewed from above. In FIG. 7, a left side is an object side and a right side is an image side. The stereoscopic optical system 100 includes two optical systems 101 and 102 arranged in parallel. The stereoscopic optical system 100 is attachable to and detachable from or integral with various image pickup apparatuses such as digital video cameras, digital still cameras, broadcasting cameras, film-based cameras, and surveillance cameras.

IP represents an image plane (paraxial imaging position). Each of the two optical systems 101 and 102 forms an optical image (image circle) on the image plane IP. Disposed on the image plane IP is an imaging surface (light receiving surface) of an image sensor such as a CCD sensor or CMOS sensor, or a film surface (photosensitive surface) of a silver film.

In the stereoscopic optical system 100 according to each of Examples 1 to 6, each of the two optical systems 101 and 102 includes, in order from the object side to the image side, a first lens unit L1 having positive refractive power, a second lens unit L2 having negative refractive power, a third lens unit L3, and a rear group including a fourth lens unit L4 and has positive refractive power as a whole. The third lens unit L3 includes a first reflective surface PR1 disposed on the object side, a second reflective surface PR2 disposed on the image side, and an aperture stop SP. In each of Examples 1 to 6, the first reflective surface PR1 and the second reflective surface PR2 are both formed on a reflector that is a prism having an entrance surface, a reflective surface (PR1 or PR2), and an exit surface, but the reflective surfaces may be provided on a mirror that is a reflector that does not have an entrance surface or an exit surface. The first reflective surface PR1 and the second reflective surface PR2 are provided to bend the optical path (optical axis) in each optical system. More specifically, the first reflective surface PR1 of each optical system reflects light incident from the object side to the other optical system in the left-right direction, and the second reflective surface PR2 reflects the light reflected by the first reflective surface PR1 to the image side. By bending the optical path in this way, a distance between optical axes Dout of the rear groups (fourth lens units L4) in the two optical systems 101 and 102 is narrower than a base line length Din, which is a distance between optical axes of the first lens units L1 in the two optical systems 101 and 102.

Therefore, as illustrated in FIG. 8, an image circle 201 and an image circle 202 are formed side by side by each of the optical systems 101 and 102 on the image plane IP (such as the imaging surface of a single image sensor). This configuration can provide two captured images (paired parallax images) that have parallax with each other and can be viewed stereoscopically by an image pickup apparatus such as a digital camera having a single image sensor.

Each of the two optical systems 101 and 102 is configured as a zoom optical system that can perform magnification variation between a wide-angle end and a telephoto end. In each optical system, (sub-lens units within) the second lens unit L2 and the fourth lens unit L4 move during magnification variation and change a distance between adjacent lens units.

In a zoom optical system, a lens unit (and sub-lens unit) is a group of one or more lenses that move together during magnification variation. That is, a distance between adjacent lens units changes during zooming. The wide-angle end and telephoto end respectively indicate zoom states with a maximum angle of view (shortest focal length) and a minimum angle of view (longest focal length) in a case where the lens unit that moves during magnification variation is located at both ends of a mechanically or controllably movable range on the optical axis.

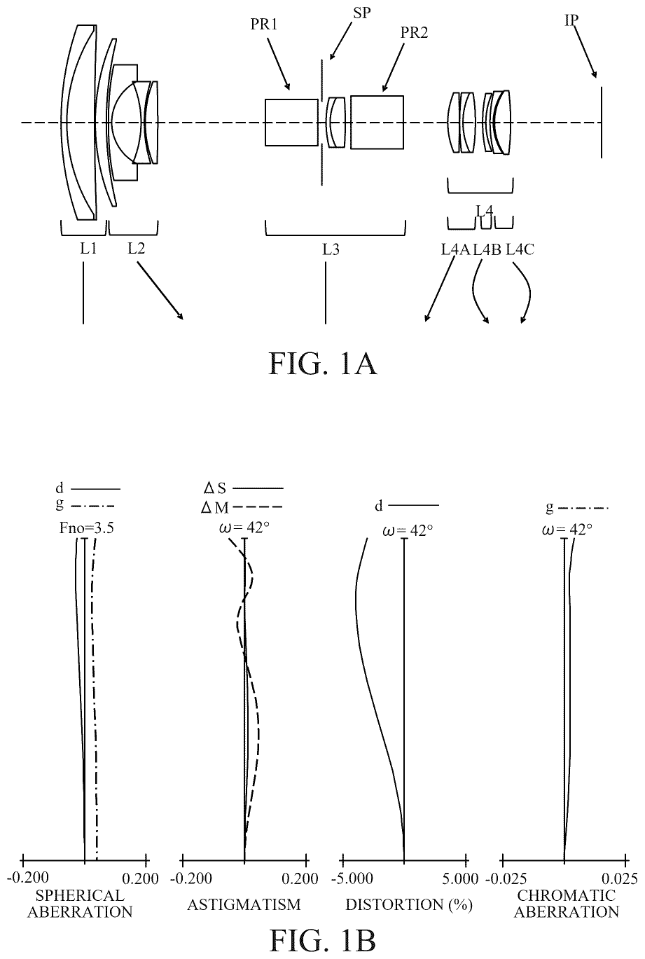

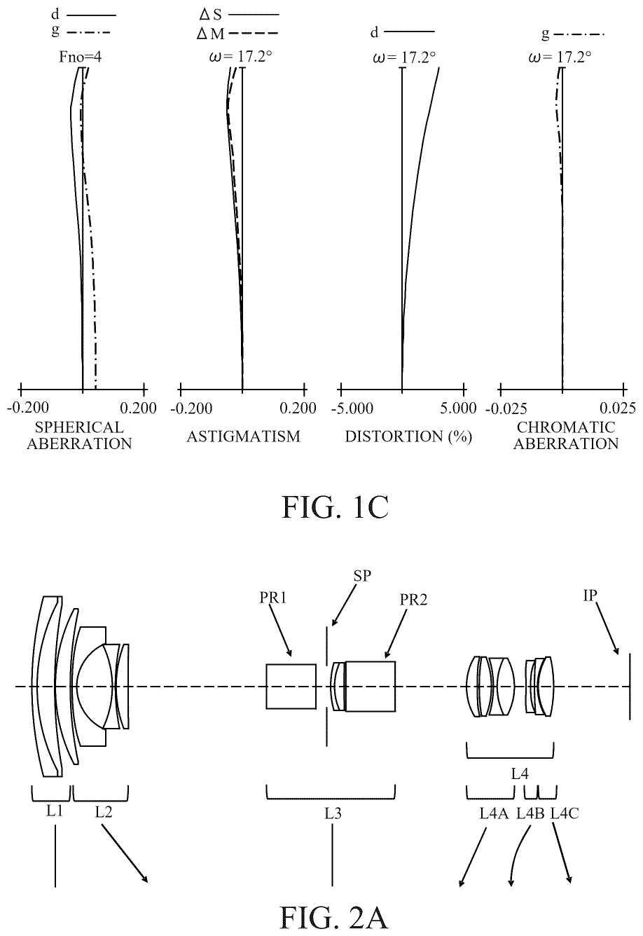

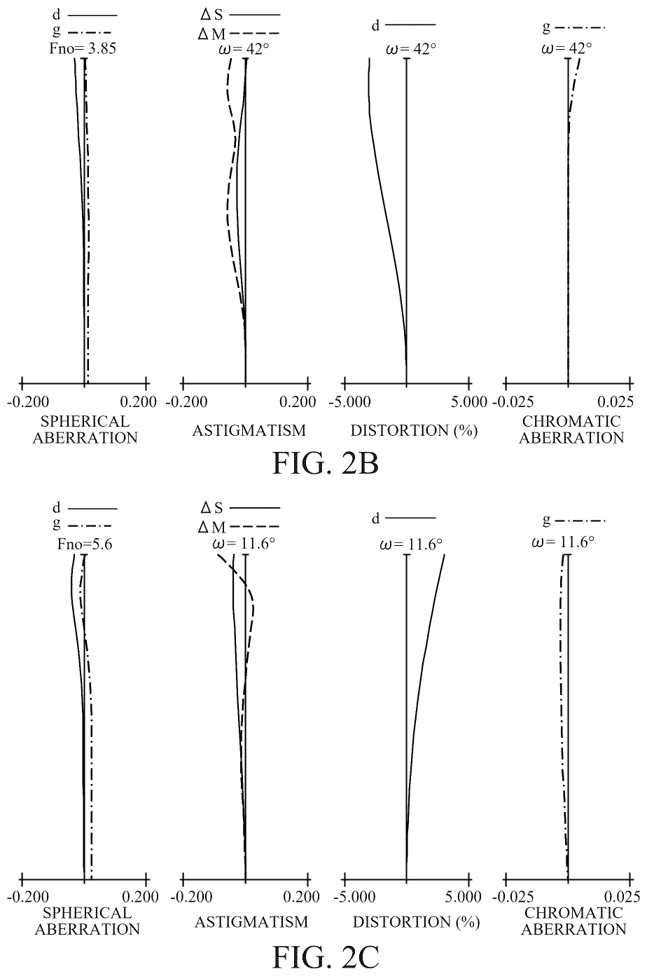

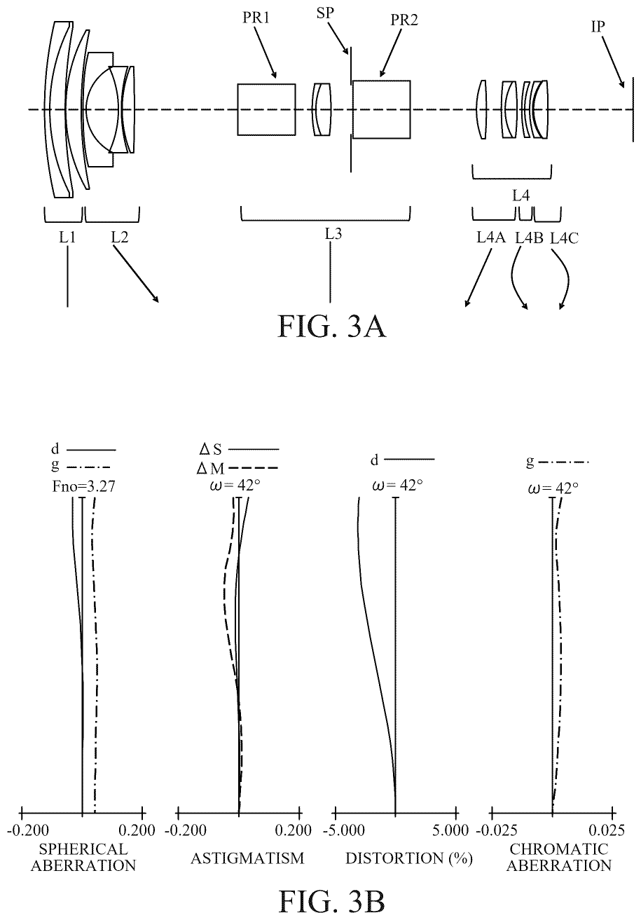

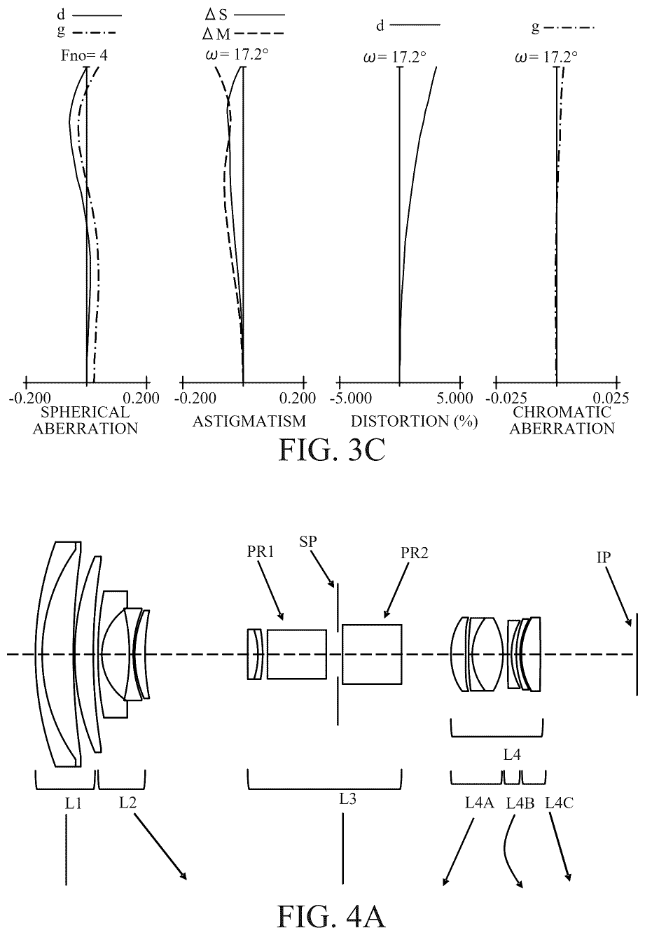

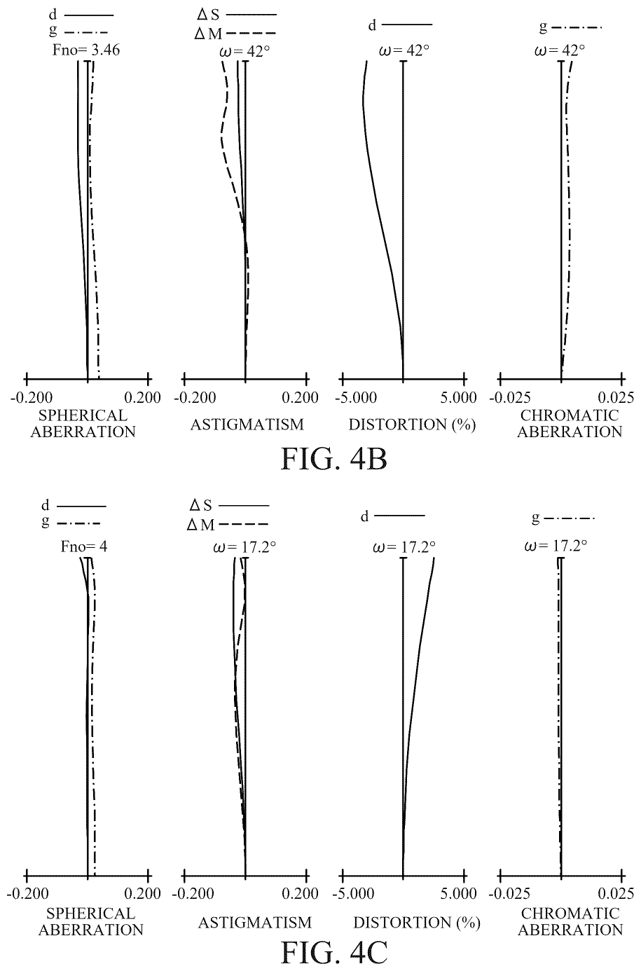

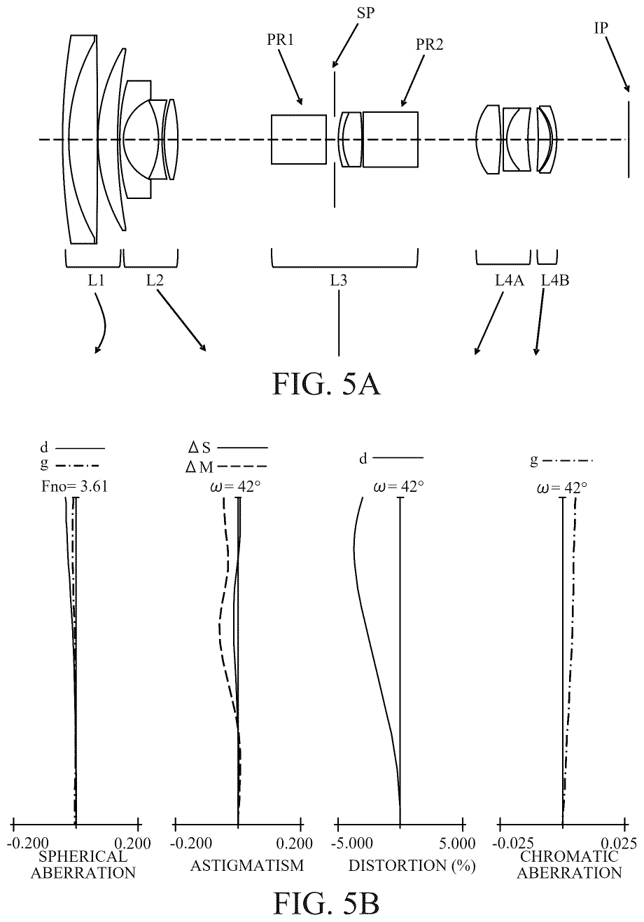

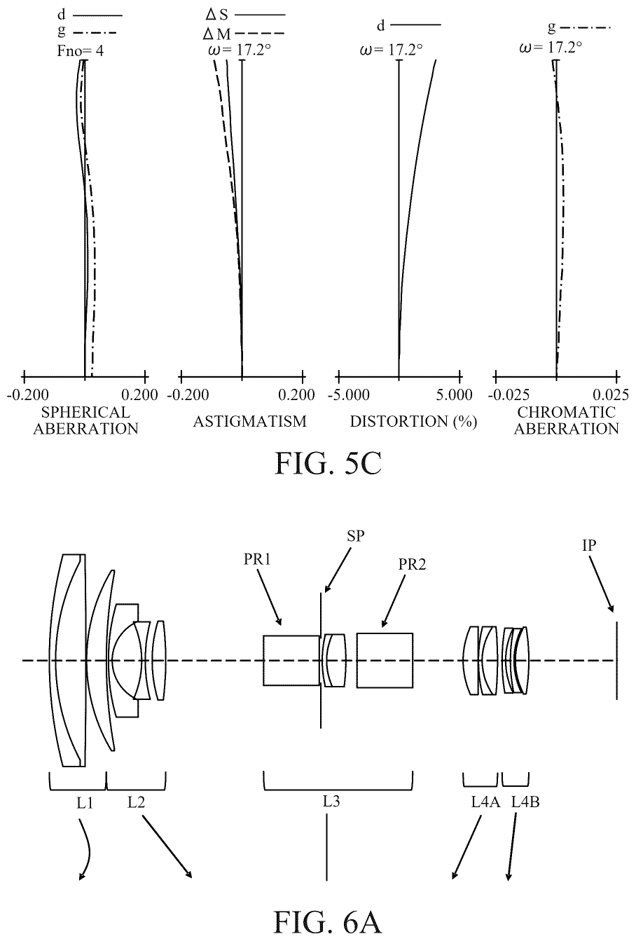

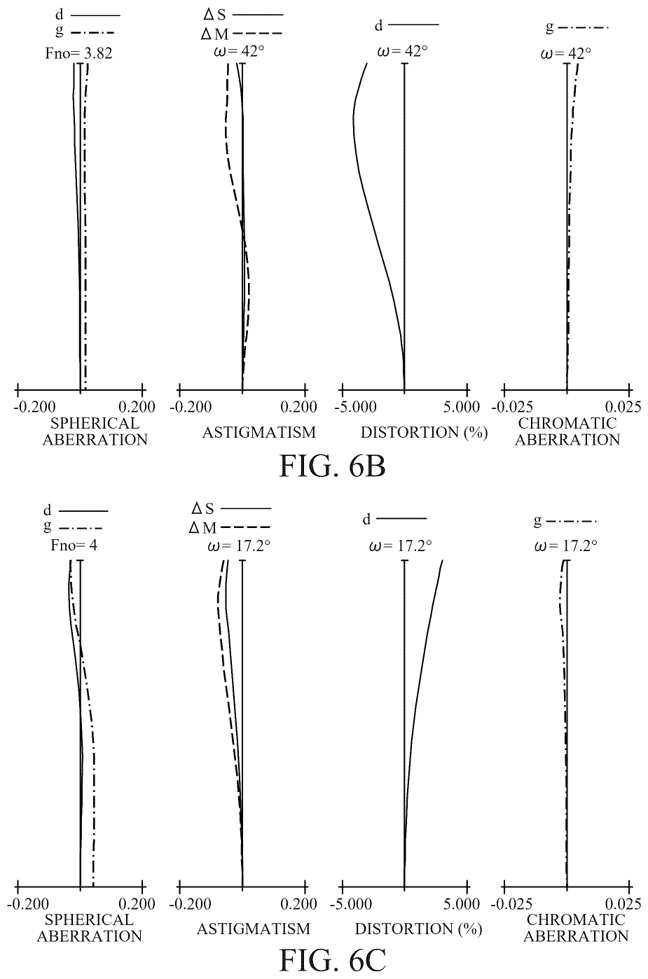

FIGS. 1A, 2A, 3A, 4A, 5A, and 6A illustrate one of the two optical systems 101 and 102 (referred to as each optical system hereinafter) in the stereoscopic optical systems according to Examples 1 to 6, respectively.

Each optical system is a positive lead zoom optical system in which the first lens unit L1 closest to the object has positive refractive power, and achieves a high magnification varying ratio while reducing the size of the entire system of each optical system. As described above, at least the second lens unit L2 and the fourth lens unit L4 move during magnification variation. The fourth lens unit L4 is divided into a plurality of sub-lens units L4s (hereinafter referred to as a fourth sub-lens units L4s, where s=1 to 3), and each of the fourth sub-lens units L4s moves to trace a different trajectory. Moving the second lens unit L2 during magnification variation can prevent a moving amount of the fourth lens unit L4 and the lens diameter of the fourth lens unit L4 from increasing. In Examples 5 and 6, the first lens unit L1 also moves. In this description, the fourth lens unit L4 is divided into a plurality of fourth sub-lens units L4s, but the plurality of fourth sub-lens units L4s may be regarded as a fourth lens unit, a fifth lens unit, a sixth lens unit, etc. That is, the rear group may include a plurality of lens units including the fourth lens unit.

In the above configuration, the following inequality (1) may be satisfied:

$$0.16 \leq \vert m 4 / f 4 \vert \leq 1.28 \qquad ( 1 )$$

where m4 is a moving amount of the fourth lens unit L4 (fourth sub-lens unit L4s) during magnification variation from the wide-angle end to the telephoto end and f4 is a focal length of the fourth lens unit L4 (fourth sub-lens unit L4s).

A moving amount of a lens unit (or sub-lens unit) is a difference between positions of the lens unit on the optical axis at the wide-angle end and the telephoto end, and does not include a reciprocating moving amount, and a sign of the moving amount is positive when the lens unit is located closer to the image side at the telephoto end than at the wide-angle end.

The lens diameter of the first lens unit L1 is to be reduced to avoid interference between the two optical systems 101 and 102 arranged in parallel. Therefore, if the first lens unit L1 and the second lens unit L2 disposed on the object side of the first reflective surface PR1 move significantly during magnification variation, a distance between the aperture stop SP and the first lens unit L1 and the lens diameter of the first lens unit L1 determined by off-axis light rays increase. Accordingly, moving the fourth lens unit L4 to a certain extent during magnification variation can achieve a high magnification varying ratio while reducing the lens diameter of the first lens unit L1.

In a case where the moving amount of the fourth lens unit L4 during magnification variation increases so that |m4/f4| becomes higher than the upper limit of inequality (1), the distance between the aperture stop SP and the fourth lens unit L4 and the lens diameter of the fourth lens unit L4 increase. As a result, interference between the fourth lens units L4 of the two optical systems 101 and 102 becomes inevitable. In a case where the focal length of the fourth lens unit L4 reduces so that m4/f4| becomes higher than the upper limit of inequality (1), the fluctuations in curvature of field and distortion during magnification variation increase, and it becomes difficult to obtain high optical performance. In a case where the moving amount of the fourth lens unit L4 during magnification variation reduces so that |m4/f4| becomes lower than the lower limit of inequality (1), a high magnification varying ratio cannot be obtained.

Inequality (1) may be replaced with inequality (la) below:

$$0.19 \leq \vert m 4 / f 4 \vert \leq 1.09 \qquad ( 1 a )$$

Inequality (1) may be replaced with inequality (1b) below:

$$0.22 \leq \vert m 4 / f 4 \vert \leq 0.94 \qquad ( 1 b )$$

Satisfying the above configuration and conditions can provide a stereoscopic optical system that has two optical systems capable of performing magnification variation while bending the optical paths, and achieves a high magnification varying ratio and high optical performance.

A description will now be given of the conditions and configurations that may be satisfied by the stereoscopic optical system according to each example. The stereoscopic optical system according to each example may satisfy at least one of the following inequalities (2) to (11) and configurations.

β2w and β4w are imaging magnifications of the second lens unit L2 and the fourth lens unit L4, respectively, at the wide-angle end in an in-focus state on an object at infinity (hereinafter referred to as an in-focus state at infinity). β2t and β4t are imaging magnifications of the second lens unit L2 and the fourth lens unit L4, respectively, at the telephoto end in the in-focus state at infinity. Z2 and Z4 are magnification varying ratios of the second lens unit L2 and the fourth lens unit L4, respectively, in the in-focus state at infinity from the wide-angle end to the telephoto end, and are defined as follows:

$$Z 2 = β 2 t / β 2 w \\ Z 4 = β 4 t / β 4 w$$

In this case, the stereoscopic optical system according to each example may satisfy the following inequality (2):

$$0.01 \leq \vert Z 2 / Z 4 \vert \leq 2.26 \qquad ( 2 )$$

In a case where |Z2/Z4| becomes higher than the upper limit of inequality (2), the magnification varying ratio of the second lens unit L2 becomes high relative to the magnification varying ratio of the fourth lens unit L4, and the moving amount of the second lens unit L2 during magnification variation increases. As a result, a distance from the first lens unit L1 to the aperture stop SP and the lens diameter of the first lens unit L1 determined by the off-axis light rays increase, and interference between the two optical systems 101 and 102 becomes inevitable. In a case where |Z2/Z4| becomes lower than the lower limit of inequality (2), the magnification varying ratio of the fourth lens unit L4 becomes high relative to the magnification varying ratio of the second lens unit L2, and the moving amount of the fourth lens unit L4 during magnification variation increases. As a result, the lens diameter of the fourth lens unit L4 determined by the off-axis light rays increases, and interference between the two optical systems 101 and 102 becomes inevitable. In addition, the refractive power of the fourth lens unit L4 increases, and the fluctuations in curvature of field and distortion aberration during magnification variation increase, and high optical performance cannot be obtained.

Inequality (2) may be replaced with inequality (2a) below:

$$0.03 \leq \vert Z 2 / Z 4 \vert \leq 2.16 \qquad ( 2 a )$$

Inequality (2) may be replaced with inequality (2b) below:

$$0.05 \leq \vert Z 2 / Z 4 \vert \leq 2.08 \qquad ( 2 b )$$

The stereoscopic optical system according to each example may satisfy the following inequality (3):

$$0.01 \leq Dout / Din \leq 0.74 \qquad ( 3 )$$

where Din is a distance between optical axes of the first lens units L1 in the two optical systems (base length), and Dout is a distance between optical axes of the rear groups (fourth lens units L4) in the two optical systems.

In a case where Dout/Din becomes lower than the lower limit of inequality (3), the base length becomes insufficient and sufficient three-dimensional sense cannot be obtained from a pair of parallax images. In a case where Dout/Din becomes lower than the upper limit of inequality (3), the parallax between the pair of parallax images becomes excessively large.

Inequality (3) may be replaced with inequality (3a) below:

$$0.03 \leq Dout / Din \leq 0.53 \qquad ( 3 a )$$

Inequality (3) may be replaced with inequality (3b) below:

$$0.18 \leq Dout / Din \leq 0.41 \qquad ( 3 b )$$

In the stereoscopic optical system according to each example, an aperture stop SP may be disposed between the first reflective surface PR1 and the second reflective surface PR2 in the third lens unit L3. In a case where the aperture stop SP is disposed on the object side of the first reflective surface PR1, a distance between the aperture stop SP and the fourth lens unit L4 and the lens diameter of the fourth lens unit L4 increase, and interference between the two optical systems 101 and 102 becomes inevitable. In a case where the aperture stop SP is disposed on the image side of the second reflective surface PR2, a distance between the aperture stop SP and the first lens unit L1 and the lens diameter of the first lens unit L1 increase, and interference between the two optical systems 101 and 102 becomes inevitable.

The stereoscopic optical system according to each example may satisfy the following inequality (4):

$$0.79 \leq dG 1 SP / dSPI \leq 1.5 \qquad ( 4 )$$

where dG1SP is a distance on the optical axis from an object-side surface of the lens closest to the object in the first lens unit L1 at the wide-angle end to the aperture stop SP, and dSPI is a distance on the optical axis from the aperture stop SP at the wide-angle end to the image plane IP.

In a case where dG1SP/dSPI becomes higher than the upper limit of inequality (4), a distance between the aperture stop SP and the first lens unit L1 and the lens diameter of the first lens unit L1 increase, and interference between the two optical systems 101 and 102 becomes inevitable. In a case where dG1SP/dSPI becomes lower than the lower limit of inequality (4), a distance between the aperture stop SP and the fourth lens unit L4 and the lens diameter of the fourth lens unit L4 increase, and interference between the two optical systems 101 and 102 becomes inevitable.

Inequality (4) may be replaced with inequality (4a) below:

$$0.82 \leq dG 1 SP / dSPI \leq 1.33 \qquad ( 4 a )$$

Inequality (4) may be replaced with inequality (4b) below:

$$0.87 \leq dG 1 SP / dSPI \leq 1.21 \qquad ( 4 b )$$

The stereoscopic optical system according to each example may satisfy the following inequality (5):

$$4.28 \leq dG 1 SP / fw \leq 11.32 \qquad ( 5 )$$

where fw is a focal length of each optical system at the wide-angle end.

In a case where dG1SP/fw becomes higher than the upper limit of inequality (5), a distance between the aperture stop SP and the first lens unit L1 and the lens diameter of the first lens unit L1 increase, and interference between the two optical systems 101 and 102 becomes inevitable. In a case where dG1SP/fw becomes lower than the lower limit of inequality (5), a distance between the aperture stop SP and the first lens unit L1 increases. As a result, a moving amount during magnification variation of the first lens unit L1 and the second lens unit L2 reduces, and it becomes difficult to secure a high magnification varying ratio and to sufficiently correct the fluctuations in curvature of field and distortion during magnification variation. Inequality (5) may be replaced with inequality (5a) below:

$$4.91 \leq dG 1 SP / fw \leq 10.24 \qquad ( 5 a )$$

Inequality (5) may be replaced with inequality (5b) below:

$$5. 53 \leq dG 1 SP / fw \leq 9.44 \qquad ( 5 b )$$

The stereoscopic optical system according to each example may satisfy the following inequality (6):

$$5. 28 \leq d SPI / fw \leq 19.09 \qquad ( 6 )$$

In a case where dSPI/fw becomes higher than the upper limit of inequality (6), a distance between the aperture stop SP and the fourth lens unit L4 and the lens diameter of the fourth lens unit L4 increase, and interference between the two optical systems 101 and 102 becomes inevitable. In a case where dSPI/fw becomes lower than the lower limit of inequality (6), a distance between the aperture stop SP and the fourth lens unit L4 and the moving amount during magnification variation of the fourth lens unit L4 reduce, and it becomes difficult to secure a high magnification varying ratio.

Inequality (6) may be replaced with inequality (6a) below:

$$5. 68 \leq dG 1 SP / fw \leq 14.79 \qquad ( 6 a )$$

Inequality (6) may be replaced with inequality (6b) below:

$$6.08 \leq dG 1 SP / fw \leq 11.57 \qquad ( 6 b )$$

The stereoscopic optical system according to each example may satisfy the following inequality (7):

$$9.55 \leq Lw / fw \leq 30.18 \qquad ( 7 )$$

where Lw is a distance on the optical axis from an object-side surface of the lens closest to the object in the first lens unit L1 at the wide-angle end to the image plane IP.

In a case where Lw/fw becomes higher than the upper limit of inequality (7), a distance between the aperture stop SP and each of the first and fourth lens units L1 and L4 and the lens diameters of the first and fourth lens units L1 and L4 increase, and interference between the two optical systems 101 and 102 becomes inevitable. In a case where Lw/fw becomes lower than the lower limit of inequality (7), a moving amount of a lens unit that moves during magnification variation reduces, and it becomes difficult to secure a high magnification varying ratio.

Inequality (7) may be replaced with inequality (7a) below:

$$10.67 \leq Lw / fw \leq 24.74 \qquad ( 7 a )$$

Inequality (7) may be replaced with inequality (7b) below:

$$11.8 \leq Lw / fw \leq 20.66 \qquad ( 7 b )$$

In the stereoscopic optical system according to each example, the third lens unit L3 may have positive refractive power. The positive refractive power of the third lens unit L3 can reduce the height of off-axis light ray and the lens diameter of the fourth lens unit L4.

In the stereoscopic optical system according to each example, the following inequality (8) may be satisfied:

$$3. 43 \leq f 3 / fw \leq 8.46 \qquad ( 8 )$$

where f3 is a focal length of the third lens unit L3.

In a case where f3/fw becomes higher than the upper limit of inequality (8), the refractive power of the third lens unit L3 becomes too small, and the lens diameter of the fourth lens unit L4 becomes too large. In a case where f3/fw becomes lower than the lower limit of inequality (8), the refractive power of the third lens unit L3 becomes too large, spherical aberration and coma are generated, and it becomes difficult to achieve high image quality.

Inequality (8) may be replaced with inequality (8a) below:

$$3. 78 \leq f 3 / fw \leq 8.26 \qquad ( 8 a )$$

Inequality (8) may be replaced with inequality (8b) below:

$$4.14 \leq f 3 / fw \leq 8.11 \qquad ( 8 b )$$

In the stereoscopic optical system according to each example, the third lens unit L3 may not move (be fixed) during magnification variation. In particular, by fixing the third lens unit L3 during magnification variation, which includes a reflective surface that has a large influence on the optical axis shift, optical axis shift becomes less likely between the two optical systems 101 and 102 and the captured image can have high image quality.

In the stereoscopic optical system according to each example, the first lens unit L1 may be fixed during magnification variation. This configuration can eliminate the optical axis shift of the first lens unit L1 during magnification variation and improve the quality of the captured image.

In the stereoscopic optical system according to each example, the following inequality (9) may be satisfied:

$$5.42 \leq f 1 / fw \leq 17.20 \qquad ( 9 )$$

where f1 is a focal length of the first lens unit L1.

In a case where f1/fw becomes higher than the upper limit of inequality (9), the refractive power of the first lens unit L1 reduces, and it becomes difficult to reduce the size of the first lens unit L1. In a case where f1/fw becomes lower than the lower limit of inequality (9), the refractive power of the first lens unit and thus lateral chromatic aberration and distortion increase, and it becomes difficult to achieve high performance.

Inequality (9) may be replaced with inequality (9a) below:

$$5.96 \leq f 1 / fw \leq 14.62 \qquad ( 9 a )$$

Inequality (9) may be replaced with inequality (9b) below:

$$6.49 \leq f 1 / fw \leq 12.68 \qquad ( 9 b )$$

The stereoscopic optical system according to each example may satisfy the following inequality (10):

$$- 12.61 \leq f 1 / f 2 \leq - 4.91 \qquad ( 10 )$$

where f2 is a focal length of the second lens unit L2.

In a case where f1/f2 becomes higher than the upper limit of inequality (10), the refractive power of the first lens unit L1 reduces and it becomes difficult to reduce the size of the first lens unit L1. In a case where f1/f2 becomes lower than the lower limit of inequality (10), the refractive power of the first lens unit L1 and lateral chromatic aberration and distortion increase, and it becomes difficult to achieve high performance.

Inequality (10) may be replaced with inequality (10a) below:

$$- 11.2 \leq f 1 / f 2 \leq - 5.29 \qquad ( 10 a )$$

Inequality (10) may be replaced with inequality (10b) below:

$$- 9.78 \leq f 1 / f 2 \leq - 5.4 \qquad ( 10 b )$$

The stereoscopic optical system according to each example may satisfy the following inequality (11):

$$2.56 \leq f 4 w / fw \leq 6.75 \qquad ( 11 )$$

where f4 is a focal length of the fourth lens unit L4 at the wide-angle end.

In a case where f4w/fw becomes higher than the upper limit of inequality (11), the refractive power of the fourth lens unit L4 reduces, and it becomes difficult to reduce the size of the fourth lens unit L4. In a case where f4w/fw becomes lower than the lower limit of inequality (11), the refractive power of the fourth lens unit L4 and lateral chromatic aberration and distortion increase, and it becomes difficult to achieve high performance.

Inequality (11) may be replaced with inequality (11a) below:

$$2.7 \leq f 4 w / fw \leq 5.74 \qquad ( 11 a )$$

Inequality (11) may be replaced with inequality (11b) below:

$$2.92 \leq f 4 w / fw \leq 4.98 \qquad ( 11 b )$$

A description will now be given of the specific configurations of the optical systems according to Examples 1 to 6. As described above, each optical system in each of Examples 1 to 6 includes, in order from the object side to the image side, a first lens unit L1 having positive refractive power, a second lens unit L2 having negative refractive power, a third lens unit L3, and a fourth lens unit L4 having positive refractive power. The third lens unit L3 has a first reflective surface PR1 on the object side and a second reflective surface PR2 on the image side. An aperture stop SP is disposed between the first reflective surface PR1 and the second reflective surface PR2 in the third lens unit L3. The third lens unit L3 in each example has positive refractive power.

In Examples 1 to 4, during magnification variation from the wide-angle end to the telephoto end, the first lens unit L1 and the third lens unit L3 do not move, and the second lens unit L2 moves toward the image side. The L4A subunit, the L4B subunit, and the L4C subunit as the fourth sub-lens unit in the fourth lens unit L4 move toward the object side or the image side so as to draw different trajectories, or move so as to draw a trajectory convex toward the object side or toward the image side. The fourth lens unit L4 (each of the L4A subunit, the L4B subunit, and the L4C subunit) satisfies inequalities (1) and (2).

In Examples 5 and 6, during magnification variation from the wide-angle end to the telephoto end, the first lens unit L1 moves to draw a trajectory that is convex toward the image side, the third lens unit L3 does not move, and the second lens unit L2 moves toward the image side. The L4A subunit and the L4B subunit as the fourth sub-lens unit constituting the fourth lens unit L4 move to draw trajectories different from each other toward the object side. The fourth lens unit L4 (each of the L4A subunit and the LAB subunit) satisfies inequalities (1) and (2).

In Examples 1 to 6, the fourth lens unit L4 moves during focusing from infinity to a close distance (or a short distance).

A description will now be given of numerical examples 1 to 6 corresponding to Examples 1 to 6, respectively. Numerical examples 1, 2, 5, and 6 are numerical examples with an image height of 8.55 mm and a base length of 60 mm. Numerical examples 3 and 4 are numerical examples with an image height of 8.55 mm and a base length of 65 mm.

In surface data of each numerical example, a surface number i indicates the order of a surface counted from the object side. r represents a radius of curvature of an i-th surface from the object side (mm), d represents a lens thickness or air gap between i-th and (i+1)-th surfaces (mm), and nd represents a refractive index for the d-line of the optical material between i-th and (i+1)-th surfaces. νd represents an Abbe number based on the d-line of the optical material between i-th and (i+1)-th surfaces. The Abbe number νd based on the d-line is expressed as νd=(Nd−1)/(NF−NC), where Nd, NF, and NC are refractive indices for the d-line (587.6 nm), F-line (486.1 nm), and C-line (656.3 nm) in the Fraunhofer lines.

BF represents back focus (mm). The back focus is a distance on the optical axis from the final surface of each optical system (a lens surface closest to the image plane) to the paraxial image surface, which is expressed in the air equivalent length. An overall lens length is a distance on the optical axis from the frontmost surface (a lens surface closest to the object) to the final surface plus the back focus of each optical system. The focal length of L4w in the lens unit data means the focal length f4w of the fourth lens unit L4 at the wide-angle end.

An asterisk “*” next to a surface number means that the surface has an aspheric shape. The aspheric shape is expressed as follows:

$$x = ( {h}^{2} / R ) {/ [ 1 + \{ 1 - ( 1 + k ) {( h / R )}^{2} \} ]}^{1 / 2} + A 4 \times {h}^{4} + A 6 \times {h}^{6} + A 8 \times {h}^{8} + A 10 \times {h}^{10}$$

where x is a displacement amount from a surface vertex in the optical axis direction, h is a height from the optical axis in a direction perpendicular to the optical axis, the light traveling direction is positive, R is a paraxial radius of curvature, k is a conic constant, and A4, A6, A8, and A10 are aspheric coefficients. “e+Z” in the conic constant and aspheric coefficient means×10^{±Z}.

Table 1 summarizes values corresponding to inequalities (1) to (11) in numerical examples 1 to 6. Table 1 illustrates the values at the d-line, which is a reference wavelength. Each numerical example satisfies all inequalities (1) to (11).

FIGS. 1B, 2B, 3B, 4B, 5B, and 6B illustrate longitudinal aberrations (spherical aberration, astigmatism, distortion, and chromatic aberration) of the optical systems according to numerical examples 1 to 6, respectively, at a wide-angle end in an in-focus state at infinity. FIGS. 1C, 2C, 3C, 4C, 5C, and 6C illustrate longitudinal aberrations of the optical systems according to numerical examples 1 to 6, respectively, at a telephoto end in an in-focus state at infinity.

In the spherical aberration diagram, Fno represents an F-number. A solid line indicates a spherical aberration amount for the d-line (with a wavelength 587.6 nm), and a dashed line indicates a spherical aberration amount for the g-line (with a wavelength 435.8 nm). In the astigmatism diagram, a solid line ΔS indicates an astigmatism amount on a sagittal image plane, and a dashed line ΔM indicates an astigmatism amount on a meridional image plane. The distortion aberration illustrates a distortion amount for the d-line. The chromatic aberration diagram illustrates a lateral chromatic aberration amount for the g-line. ω is a half angle of view (°).

### Numerical Example 1

UNIT: mm
SURFACE DATA

| Surface No. | r | d | nd | νd |
|---|---|---|---|---|
| 1 | 70.960 | 1.40 | 1.85478 | 24.8 |
| 2 | 41.105 | 6.75 | 1.65160 | 58.5 |
| 3 | 545.417 | 0.13 | | |
| 4 | 50.902 | 2.72 | 1.77250 | 49.6 |
| 5 | 82.654 | (Variable) | | |
| 6* | 109.835 | 0.80 | 1.85400 | 40.4 |
| 7 | 11.171 | 7.11 | | |
| 8 | −24.805 | 0.80 | 1.65160 | 58.5 |
| 9 | 33.425 | 0.20 | | |
| 10 | 26.597 | 3.03 | 1.84666 | 23.8 |
| 11 | −333.322 | (Variable) | | |
| 12 | ∞ | 12.69 | 1.60311 | 60.6 |
| 13 | ∞ | 1.00 | | |
| 14 (SP) | ∞ | 1.00 | | |
| 15 | 24.213 | 1.00 | 1.77250 | 49.6 |
| 16 | 12.947 | 3.67 | 1.51823 | 58.9 |
| 17 | −76.343 | 1.38 | | |
| 18 | ∞ | 12.69 | 1.60311 | 60.6 |
| 19 | ∞ | (Variable) | | |
| 20* | 17.896 | 2.82 | 1.58313 | 59.4 |
| 21 | −223.699 | 0.07 | | |
| 22 | 61.799 | 0.80 | 1.83481 | 42.7 |
| 23 | 16.759 | 3.01 | 1.49700 | 81.5 |
| 24 | −44.366 | (Variable) | | |
| 25 | 32.639 | 0.79 | 1.83481 | 42.7 |
| 26 | 17.139 | (Variable) | | |
| 27 | 30.205 | 0.79 | 1.85150 | 40.8 |
| 28 | 13.144 | 0.31 | | |
| 29 | 13.781 | 3.90 | 1.49700 | 81.5 |
| 30 | −64.874 | (Variable) | | |
| Image Plane | ∞ | | | |

ASPHERIC DATA
6th Surface
K = 0.00000e+00 A 4 = 1.79021e−05 A 6 = −2.28987e−08
A 8 = −9.85171e−11 A10 = 2.62132e−13
20th Surface
K = 0.00000e+00 A 4 = −2.53762e−05 A 6 = 9.39343e−09
A 8 = −3.36281e−10 A10 = 2.37435e−13

VARIOUS DATA
ZOOM RATIO 2.92

| | WIDE | TELE |
|---|---|---|
| Focal Length | 9.49 | 27.66 |
| Fno | 3.55 | 4.00 |
| Half Angle of View (°) | 42.03 | 17.17 |
| Image Height | 8.55 | 8.55 |
| Overall Lens Length | 131.09 | 131.09 |
| BF | 22.09 | 27.01 |
| d5 | 0.50 | 23.61 |
| d11 | 26.11 | 3.00 |
| d19 | 10.77 | 0.50 |
| d24 | 1.57 | 5.98 |
| d26 | 1.18 | 2.11 |
| d30 | 22.09 | 27.01 |

LENS UNIT DATA

| Lens Unit | Starting Surface | Focal Length |
|---|---|---|
| L1 | 1 | 84.06 |
| L2 | 6 | −12.02 |
| L3 | 12 | 52.42 |
| L4w | 20 | 37.10 |
| L4A | 20 | 25.74 |
| L4B | 25 | −44.26 |
| L4C | 27 | 127.13 |

### Numerical Example 2

UNIT: mm
SURFACE DATA

| Surface No. | r | d | nd | νd |
|---|---|---|---|---|
| 1 | 92.007 | 1.40 | 1.84666 | 23.8 |
| 2 | 47.964 | 4.59 | 1.69680 | 55.5 |
| 3 | 122.207 | 0.13 | | |
| 4 | 44.067 | 3.91 | 1.77250 | 49.6 |
| 5 | 92.340 | (Variable) | | |
| 6* | 84.056 | 1.20 | 1.85135 | 40.1 |
| 7 | 12.156 | 9.30 | | |
| 8 | −25.060 | 0.80 | 1.65160 | 58.5 |
| 9 | 54.936 | 0.20 | | |
| 10 | 30.941 | 3.17 | 1.85478 | 24.8 |
| 11 | 900.218 | (Variable) | | |
| 12 | ∞ | 12.88 | 1.60311 | 60.6 |
| 13 | ∞ | 2.88 | | |
| 14 (SP) | ∞ | 1.00 | | |
| 15 | 22.760 | 1.00 | 1.85150 | 40.8 |
| 16 | 15.035 | 2.49 | 1.51742 | 52.4 |
| 17 | 206.824 | 0.50 | | |
| 18 | ∞ | 12.88 | 1.60311 | 60.6 |
| 19 | ∞ | (Variable) | | |
| 20* | 16.294 | 2.81 | 1.58313 | 59.4 |
| 21* | 194.929 | 0.50 | | |
| 22 | 51.836 | 3.17 | 1.57501 | 41.5 |
| 23 | −21.849 | 0.50 | | |
| 24 | −25.879 | 1.00 | 1.85150 | 40.8 |
| 25 | 16.661 | 4.51 | 1.49700 | 81.5 |
| 26 | −16.174 | (Variable) | | |
| 27* | −36.831 | 1.20 | 1.76802 | 49.2 |
| 28* | 63.090 | (Variable) | | |
| 29 | 94.355 | 0.79 | 1.85150 | 40.8 |
| 30 | 15.448 | 0.20 | | |
| 31 | 15.407 | 4.03 | 1.49700 | 81.5 |
| 32 | −33.625 | (Variable) | | |
| Image Plane | ∞ | | | |

ASPHERIC DATA
6th Surface
K = 0.00000e+00 A 4 = 1.98792e−05 A 6 = −5.12977e−08
A 8 = 1.19023e−10 A10 = −1.39437e−13
20th Surface
K = 0.00000e+00 A 4 = 3.16475e−05 A 6 = 4.91822e−07
A 8 = −2.57805e−09 A10 = −4.03369e−11
21st Surface
K = 0.00000e+00 A 4 = 1.20888e−04 A 6 = 7.65121e−07
A 8 = −7.08168e−09 A10 = −1.61213e−11
27th Surface
K = 0.00000e+00 A 4 = 6.98682e−04 A 6 = −1.24476e−05
A 8 = 1.15600e−07 A10 = −1.44487e−10
28th Surface
K = 0.00000e+00 A 4 = 7.16637e−04 A 6 = −1.04228e−05
A 8 = 5.01853e−08 A10 = 7.22580e−10

VARIOUS DATA
ZOOM RATIO 4.37

| | WIDE | TELE |
|---|---|---|
| Focal Length | 9.49 | 41.50 |
| Fno | 3.85 | 5.60 |
| Half Angle of View (°) | 42.03 | 11.64 |
| Image Height | 8.55 | 8.55 |
| Overall Lens Length | 156.30 | 156.30 |
| BF | 19.92 | 13.50 |
| d5 | 0.50 | 33.59 |
| d11 | 36.15 | 3.06 |
| d19 | 18.64 | 0.50 |
| d26 | 2.94 | 5.18 |
| d28 | 1.11 | 23.43 |
| d32 | 19.92 | 13.50 |

LENS UNIT DATA

| Lens Unit | Starting Surface | Focal Length |
|---|---|---|
| L1 | 1 | 101.98 |
| L2 | 6 | −13.24 |
| L3 | 12 | 75.45 |
| L4w | 20 | 40.04 |
| L4A | 20 | 22.68 |
| L4B | 27 | −30.12 |
| L4C | 29 | 515.74 |

### Numerical Example 3

UNIT: mm
SURFACE DATA

| Surface No. | r | d | nd | νd |
|---|---|---|---|---|
| 1 | 102.069 | 1.40 | 1.84666 | 23.8 |
| 2 | 49.796 | 4.12 | 1.69680 | 55.5 |
| 3 | 119.088 | 0.13 | | |
| 4 | 43.606 | 4.16 | 1.77250 | 49.6 |
| 5 | 102.177 | (Variable) | | |
| 6* | 191.960 | 0.80 | 1.85150 | 40.8 |
| 7 | 12.787 | 7.83 | | |
| 8 | −26.768 | 0.80 | 1.65160 | 58.5 |
| 9 | 39.717 | 0.20 | | |
| 10 | 30.906 | 3.29 | 1.85478 | 24.8 |
| 11 | −314.792 | (Variable) | | |
| 12 | ∞ | 15.33 | 1.60311 | 60.6 |
| 13 | ∞ | 4.54 | | |
| 14 | 34.319 | 1.00 | 1.85150 | 40.8 |
| 15 | 17.568 | 4.05 | 1.51742 | 52.4 |
| 16 | −56.025 | 5.34 | | |
| 17 (SP) | ∞ | 0.50 | | |
| 18 | ∞ | 15.33 | 1.60311 | 60.6 |
| 19 | ∞ | (Variable) | | |
| 20* | 21.928 | 2.68 | 1.58313 | 59.4 |
| 21 | −95.663 | 4.00 | | |
| 22 | 68.963 | 1.00 | 1.85150 | 40.8 |
| 23 | 15.007 | 3.19 | 1.49700 | 81.5 |
| 24 | −70.170 | (Variable) | | |
| 25 | 36.048 | 0.79 | 1.80400 | 46.5 |
| 26 | 20.601 | (Variable) | | |
| 27 | 24.453 | 0.79 | 1.85150 | 40.8 |
| 28 | 12.887 | 0.27 | | |
| 29 | 13.304 | 3.85 | 1.49700 | 81.5 |
| 30 | −95.905 | (Variable) | | |
| Image Plane | ∞ | | | |

ASPHERIC DATA
6th Surface
K = 0.00000e+00 A 4 = 2.45514e−05 A 6 = −5.93442e−08 A 8 = 1.15631e−10
A10 = −1.26900e−13
20th Surface
K = 0.00000e+00 A 4 = −1.10517e−05 A 6 = 4.37172e−08 A 8 = −8.66814e−10
A10 = 4.72732e−12

VARIOUS DATA
ZOOM RATIO 2.91

| | WIDE | TELE |
|---|---|---|
| Focal Length | 9.50 | 27.66 |
| Fno | 3.27 | 4.00 |
| Half Angle of View (°) | 41.98 | 17.18 |
| Image Height | 8.55 | 8.55 |
| Overall Lens Length | 157.50 | 157.50 |
| BF | 22.76 | 18.81 |
| d5 | 0.50 | 26.02 |
| d11 | 28.53 | 3.00 |
| d19 | 17.74 | 0.50 |
| d24 | 1.27 | 10.74 |
| d26 | 1.31 | 13.04 |
| d30 | 22.76 | 18.81 |

LENS UNIT DATA

| Lens Unit | Starting Surface | Focal Length |
|---|---|---|
| L1 | 1 | 101.76 |
| L2 | 6 | −13.22 |
| L3 | 12 | 66.61 |
| L4w | 20 | 39.20 |
| L4A | 20 | 34.51 |
| L4B | 25 | −61.19 |
| L4C | 27 | 84.07 |

### Numerical Example 4

UNIT: mm
SURFACE DATA

| Surface No. | r | d | nd | νd |
|---|---|---|---|---|
| 1 | 67.518 | 1.40 | 1.85478 | 24.8 |
| 2 | 37.899 | 6.53 | 1.69680 | 55.5 |
| 3 | 148.754 | 0.30 | | |
| 4 | 51.376 | 3.89 | 1.77250 | 49.6 |
| 5 | 120.870 | (Variable) | | |
| 6* | 86.308 | 0.80 | 1.85400 | 40.4 |
| 7 | 11.675 | 5.80 | | |
| 8 | −41.114 | 0.80 | 1.77250 | 49.6 |
| 9 | 25.244 | 0.30 | | |
| 10 | 22.648 | 2.17 | 2.00069 | 25.5 |
| 11 | 48.264 | (Variable) | | |
| 12 | 246.513 | 2.17 | 1.68893 | 31.1 |
| 13 | −16.340 | 1.00 | 2.00100 | 29.1 |
| 14 | −29.961 | 1.00 | | |
| 15 | ∞ | 12.35 | 1.60311 | 60.6 |
| 16 | ∞ | 2.40 | | |
| 17 (SP) | ∞ | 1.00 | | |
| 18 | ∞ | 12.35 | 1.60311 | 60.6 |
| 19 | ∞ | (Variable) | | |
| 20* | 15.290 | 3.09 | 1.58313 | 59.4 |
| 21* | −247.681 | 0.57 | | |
| 22 | 58.830 | 0.80 | 1.71700 | 47.9 |
| 23 | 11.908 | 6.44 | 1.49700 | 81.5 |
| 24 | −15.403 | (Variable) | | |
| 25 | 221.388 | 0.79 | 1.83481 | 42.7 |
| 26 | 14.591 | (Variable) | | |
| 27 | 20.787 | 0.79 | 2.00069 | 25.5 |
| 28 | 15.133 | 0.30 | | |
| 29 | 14.942 | 3.97 | 1.49700 | 81.5 |
| 30 | −310.982 | (Variable) | | |
| Image Plane | ∞ | | | |

ASPHERIC DATA
6th Surface
K = 0.00000e+00 A 4 = 1.26227e−05 A 6 = −3.13028e−08 A 8 = −2.71222e−11
A10 = 1.54592e−13
20th Surface
K = 0.00000e+00 A 4 = 3.46778e−05 A 6 = 6.66170e−07 A 8 = −5.39970e−09
A10 = 1.12567e−10
21st Surface
K = 0.00000e+00 A 4 = 1.49005e−04 A 6 = 8.76476e−07 A 8 = −6.22349e−09
A10 = 1.31982e−10

VARIOUS DATA
ZOOM RATIO 2.92

| | WIDE | TELE |
|---|---|---|
| Focal Length | 9.49 | 27.66 |
| Fno | 3.46 | 4.00 |
| Half Angle of View (°) | 42.03 | 17.17 |
| Image Height | 8.55 | 8.55 |
| Overall Lens Length | 126.15 | 126.15 |
| BF | 20.26 | 14.65 |
| d5 | 1.00 | 21.49 |
| d11 | 21.49 | 1.00 |
| d19 | 10.38 | 1.00 |
| d24 | 1.00 | 6.89 |
| d26 | 1.00 | 10.10 |
| d30 | 20.26 | 14.65 |

LENS UNIT DATA

| Lens Unit | Starting Surface | Focal Length |
|---|---|---|
| L1 | 1 | 79.54 |
| L2 | 6 | −10.09 |
| L3 | 12 | 57.72 |
| L4w | 20 | 28.47 |
| L4A | 20 | 17.08 |
| L4B | 25 | −18.74 |
| L6C | 27 | 56.90 |

### Numerical Example 5

UNIT: mm
SURFACE DATA

| Surface No. | r | d | nd | νd |
|---|---|---|---|---|
| 1 | 144.838 | 1.40 | 2.00069 | 25.5 |
| 2 | 45.321 | 6.50 | 1.65160 | 58.5 |
| 3 | −1499.692 | 0.10 | | |
| 4 | 40.196 | 4.46 | 1.91082 | 35.2 |
| 5 | 112.258 | (Variable) | | |
| 6* | 74.986 | 0.80 | 1.85400 | 40.4 |
| 7 | 9.788 | 7.95 | | |
| 8 | −18.639 | 0.80 | 1.75500 | 52.3 |
| 9 | 37.411 | 0.52 | | |
| 10 | 31.164 | 3.07 | 1.84666 | 23.8 |
| 11 | −40.889 | (Variable) | | |
| 12 | ∞ | 12.35 | 1.60311 | 60.6 |
| 13 | ∞ | 1.94 | | |
| 14 (SP) | ∞ | 0.83 | | |
| 15 | 20.460 | 1.00 | 1.90043 | 37.4 |
| 16 | 13.834 | 4.33 | 1.48749 | 70.2 |
| 17 | −64.755 | 0.30 | | |
| 18 | ∞ | 12.35 | 1.60311 | 60.6 |
| 19 | ∞ | (Variable) | | |
| 20* | 12.793 | 5.56 | 1.58313 | 59.4 |
| 21* | −44.483 | 0.56 | | |
| 22 | 449.325 | 0.80 | 1.85150 | 40.8 |
| 23 | 9.511 | 4.80 | 1.49700 | 81.5 |
| 24 | 40.349 | (Variable) | | |
| 25 | −99.879 | 2.75 | 1.51823 | 58.9 |
| 26 | −10.958 | 0.43 | | |
| 27 | −10.278 | 1.00 | 1.71700 | 47.9 |
| 28 | −19.656 | (Variable) | | |
| Image Plane | ∞ | | | |

ASPHERIC DATA
6th Surface
K = 0.00000e+00 A 4 = 3.48110e−05 A 6 = −1.58823e−07 A 8 = 5.07462e−10
A10 = −9.45667e−13
20th Surface
K = 0.00000e+00 A 4 = −1.41902e−05 A 6 = 1.53238e−07 A 8 = −2.70259e−09
A10 = 4.22423e−11
21st Surface
K = 0.00000e+00 A 4 = 5.59996e−05 A 6 = 1.52335e−08 A 8 = −7.94237e−11
A10 = 3.28230e−11

VARIOUS DATA
ZOOM RATIO 2.92

| | WIDE | TELE |
|---|---|---|
| Focal Length | 9.49 | 27.66 |
| Fno | 3.61 | 4.00 |
| Half Angle of View (°) | 42.02 | 17.18 |
| Image Height | 8.55 | 8.55 |
| Overall Lens Length | 128.15 | 128.15 |
| BF | 16.32 | 27.72 |
| d5 | 0.50 | 20.68 |
| d11 | 21.18 | 1.00 |
| d19 | 13.21 | 0.50 |
| d24 | 2.34 | 3.65 |
| d28 | 16.32 | 27.72 |

LENS UNIT DATA

| Lens Unit | Starting Surface | Focal Length |
|---|---|---|
| L1 | 1 | 68.40 |
| L2 | 6 | −11.70 |
| L3 | 12 | 45.70 |
| L4w | 20 | 38.14 |
| L4A | 20 | 48.97 |
| L4B | 25 | 98.74 |

### Numerical Example 6

UNIT: mm
SURFACE DATA

| Surface No. | r | d | nd | νd |
|---|---|---|---|---|
| 1 | 91.888 | 1.40 | 2.00069 | 25.5 |
| 2 | 47.090 | 6.75 | 1.51633 | 64.1 |
| 3 | −1258.987 | 0.13 | | |
| 4 | 38.679 | 4.39 | 1.80400 | 46.5 |
| 5 | 105.557 | (Variable) | | |
| 6* | 54.811 | 0.80 | 1.85400 | 40.4 |
| 7 | 9.450 | 6.56 | | |
| 8 | −20.945 | 0.80 | 1.75500 | 52.3 |
| 9 | 34.554 | 1.54 | | |
| 10 | 30.437 | 3.00 | 1.84666 | 23.8 |
| 11 | −69.701 | (Variable) | | |
| 12 | ∞ | 12.35 | 1.60311 | 60.6 |
| 13 | ∞ | 0.35 | | |
| 14 (SP) | ∞ | 0.30 | | |
| 15 | 24.119 | 1.00 | 1.85150 | 40.8 |
| 16 | 13.915 | 4.26 | 1.51633 | 64.1 |
| 17 | −43.688 | 2.48 | | |
| 18 | ∞ | 12.35 | 1.60311 | 60.6 |
| 19 | ∞ | (Variable) | | |
| 20* | 17.361 | 3.38 | 1.58313 | 59.4 |
| 21 | −2140.456 | 0.05 | | |
| 22 | 32.099 | 0.80 | 1.85150 | 40.8 |
| 23 | 13.137 | 3.44 | 1.49700 | 81.5 |
| 24 | −75.609 | (Variable) | | |
| 25 | 43.571 | 0.79 | 1.77250 | 49.6 |
| 26 | 15.989 | 1.06 | | |
| 27 | 35.841 | 0.79 | 1.83481 | 42.7 |
| 28 | 15.881 | 0.30 | | |
| 29 | 15.879 | 3.00 | 1.49700 | 81.5 |
| 30 | −45.290 | (Variable) | | |
| Image Plane | ∞ | | | |

ASPHERIC DATA
6th Surface
K = 0.00000e+00 A 4 = 2.21645e−05 A 6 = −9.05090e−08 A 8 = 2.08340e−10
A10 = −5.50415e−13
20th Surface
K = 0.00000e+00 A 4 = −2.43104e−05 A 6 = 6.87502e−08 A 8 = −1.89488e−09
A10 = 1.25521e−11

VARIOUS DATA
ZOOM RATIO 2.92

| | WIDE | TELE |
|---|---|---|
| Focal Length | 9.49 | 27.66 |
| Fno | 3.82 | 4.00 |
| Half Angle of View (°) | 42.03 | 17.17 |
| Image Height | 8.55 | 8.55 |
| Overall Lens Length | 126.06 | 126.06 |
| BF | 19.54 | 28.32 |
| d5 | 0.50 | 21.26 |
| d11 | 21.76 | 1.00 |
| d19 | 11.18 | 0.50 |
| d24 | 1.00 | 2.90 |
| d30 | 19.54 | 28.32 |

LENS UNIT DATA

| Lens Unit | Starting Surface | Focal Length |
|---|---|---|
| L1 | 1 | 68.88 |
| L2 | 6 | −11.42 |
| L3 | 12 | 43.70 |
| L4w | 20 | 38.26 |
| L4A | 20 | 25.31 |
| L4B | 25 | −64.34 |

TABLE 1

| | Numerical Example | | | | | |
|---|---|---|---|---|---|---|
| | 1 | 2 | 3 | 4 | 5 | 6 |
| Inequality (1) | 0.40 | 0.80 | 0.50 | 0.55 | 0.26 | 0.42 |
| Inequality (2) | 0.40 | 0.09 | 0.07 | 0.40 | 1.45 | 2.00 |
| Inequality (3) | 0.31 | 0.31 | 0.23 | 0.37 | 0.31 | 0.31 |
| Inequality (4) | 0.93 | 0.97 | 1.09 | 1.01 | 0.93 | 0.92 |
| Inequality (5) | 6.67 | 8.13 | 8.63 | 6.68 | 6.49 | 6.36 |
| Inequality (6) | 7.15 | 8.35 | 7.94 | 6.62 | 7.02 | 6.93 |
| Inequality (7) | 13.82 | 16.48 | 16.57 | 13.30 | 13.51 | 13.29 |
| Inequality (8) | 5.53 | 7.95 | 7.01 | 6.08 | 4.82 | 4.61 |
| Inequality (9) | 8.86 | 10.75 | 10.71 | 8.39 | 7.21 | 7.26 |
| Inequality (10) | −7.00 | −7.70 | −7.70 | −7.88 | −5.85 | −6.03 |
| Inequality (11) | 3.91 | 4.22 | 4.12 | 3.00 | 4.02 | 4.03 |

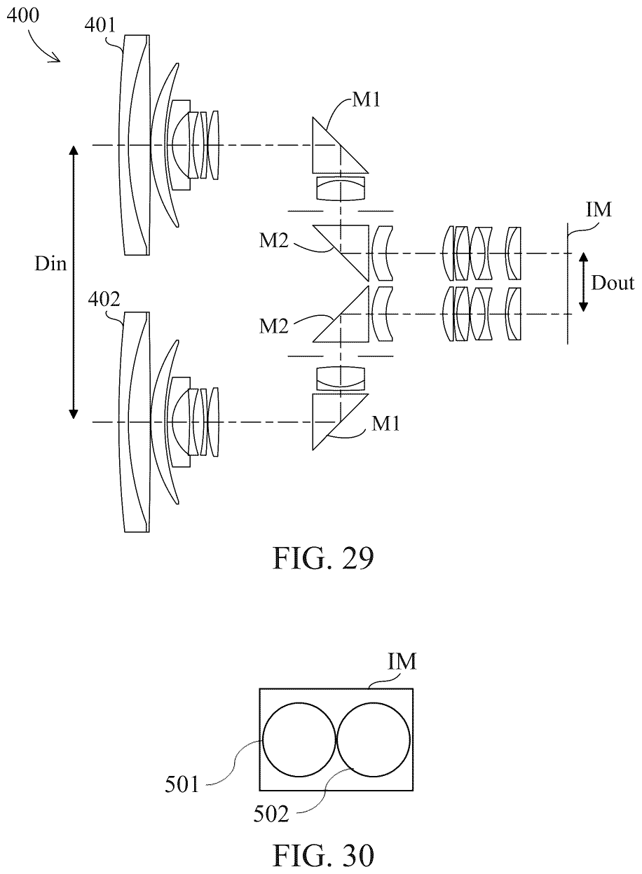

FIG. 29 illustrates the basic configuration of each of the stereoscopic optical systems 400 according to Examples 7 to 10 viewed from above. In FIG. 29, a left side is an object side and a right side is an image side. The stereoscopic optical system 400 includes two optical systems 401 and 402 arranged in parallel. The stereoscopic optical system 400 is attachable to and detachable from or integral with various image pickup apparatuses such as digital video cameras, digital still cameras, broadcasting cameras, film-based cameras, and surveillance cameras.

IM represents an image plane (paraxial imaging position). Each of the two optical systems 401 and 402 forms an optical image (image circle) on the image plane IM. Disposed on the image plane IM is an imaging surface (light receiving surface) of an image sensor such as a CCD sensor or CMOS sensor, or a film surface (photosensitive surface) of a silver film.

In the stereoscopic optical system 400 according to each example, each of the two optical systems 401 and 402 includes, in order from the object side to the image side, a first lens unit L1 having positive refractive power, a second lens unit L2 having negative refractive power, a third lens unit L3, and a rear group LR including at least one lens unit. The third lens unit L3 includes a first reflective surface M1 disposed on the object side, a second reflective surface M2 disposed on the image side, and an aperture stop SP. The aperture stop SP determines (limits) a light beam of the maximum aperture (minimum F-number or Fno).

In each embodiment, the first reflective surface M1 and the second reflective surface M2 are both formed on a reflector that is a prism having an entrance surface, a reflective surface (M1 or M2), and an exit surface, but the reflective surfaces may be provided on a mirror that is a reflector that does not have an entrance surface or an exit surface.

The first reflective surface M1 and the second reflective surface M2 are provided to bend the optical path (optical axis) in each optical system. More specifically, the first reflective surface M1 of each optical system reflects the light incident from the object side to the other optical system in the left-right direction, and the second reflective surface M2 reflects the light reflected by the first reflective surface M1 to the image side. By bending the optical path in this way, the distance between the optical axes Dout of the rear groups LR is narrower than the base line length Din, which is the distance between the optical axes of the first lens units L1 of the two optical systems 401 and 402.

As illustrated in FIG. 30, an image circle 501 and an image circle 502 are formed side by side by the optical systems 401 and 402 on the image plane IM (such as the imaging surface of a single image sensor). This configuration can obtain two captured images (paired parallax images) that have parallax with each other and can be viewed stereoscopically by an image pickup apparatus such as a digital camera having a single image sensor.

Each of the two optical systems 401 and 402 is configured as a zoom optical system that can perform magnification variation between the wide-angle end and the telephoto end. In each optical system, at least the second lens unit L2 moves during magnification variation.

In a zoom optical system, a lens unit is a group of one or more lenses that move together during magnification variation or focusing. That is, a distance between adjacent lens units changes during magnification variation or focusing. The wide-angle end and telephoto end in magnification variation indicate a maximum angle of view (shortest focal length) and minimum angle of view (longest focal length) states in a case where the lens unit that moves during magnification variation is located at both ends of a mechanically or controllably movable range on the optical axis.

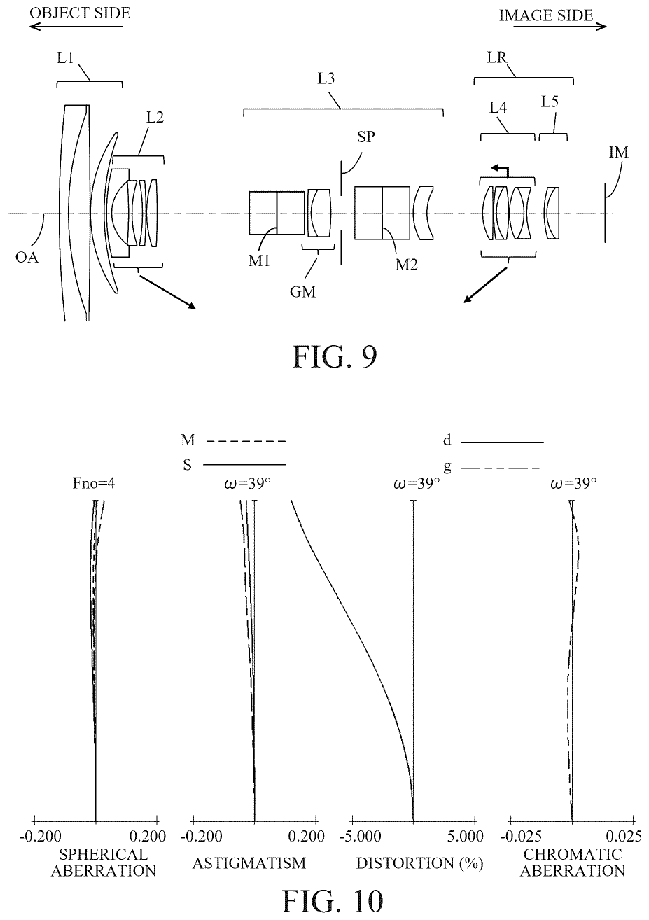

FIGS. 9, 14, 19, and 24 illustrate one of the two optical systems 401 and 402 of the stereoscopic optical systems according to Examples 7 to 10 (referred to as each optical system hereinafter). OA in each figure indicates an optical axis.

Each optical system is a positive lead zoom optical system in which the first lens unit L1, which is closest to the object, has positive refractive power, and achieves a high magnification varying ratio while reducing the overall size of each optical system. As described above, in each example, at least the second lens unit L2 moves during magnification variation. This configuration can achieve a high magnification varying ratio. In Examples 1, 3, and 4, the second lens unit L2 and the fourth lens unit L4 move during magnification variation. This configuration can prevent a moving amount of the fourth lens unit L4 and the lens diameter (effective diameter) of the fourth lens unit L4 from increasing. In Example 2, the first lens unit L1 and the second lens unit L2 move during magnification variation.

In the above configuration, the following inequality (12) may be satisfied:

$$3.5 \leq f 1 / fw \leq 32. \qquad ( 12 )$$

where fw is a focal length of each optical system at the wide-angle end, and f1 is a focal length of the first lens unit L1.

In a case where f1 increases so that f1/fw becomes higher than the upper limit of inequality (12), the size of the entire optical system increases, and it becomes difficult to obtain a high magnification varying ratio. In a case where fw increases so that f1/fw becomes lower than the lower limit of inequality (12), it becomes difficult to achieve a wide angle of each optical system.

Inequality (12) may be replaced with inequality (12a) below:

$$3.6 \leq f 1 / fw \leq 30. \qquad ( 12 a )$$

Inequality (12) may be replaced with inequality (12b) below:

$$3.7 \leq f 1 / fw \leq 28. \qquad ( 12 b )$$

Satisfying the above configuration and conditions can achieve a stereoscopic optical system that includes two optical systems capable of magnification variation, arranged in parallel, and configured to bend the optical paths, and has a sufficient base length, a wide angle, and a high magnification varying ratio.

A description will now be given of the configuration and conditions that each optical system may satisfy. Each optical system may satisfy at least one of the following configurations and inequalities (13) to (20).

Each optical system may have a configuration that does not form an intermediate image. This configuration reduces the overall length of the optical system.

In each optical system, the third lens unit L3 may not move (be fixed) during magnification variation. This configuration can simplify the mechanism for driving the lens unit that moves during magnification variation.

In each optical system, an aperture stop SP may be provided between the first reflective surface M1 and the second reflective surface M2. This configuration can suppress an increase in lens diameter of the entire optical system, and reduce the size of the entire optical system.

In each optical system, the following inequality (13) may be satisfied:

$$0.05 \leq Dm / Lw \leq 0.5 \qquad ( 13 )$$

where Dm is a distance on the optical axis between the first reflective surface M1 and the second reflective surface M2, and Lw is an overall optical length of the optical system at the wide-angle end.

In a case where Dm increases so that Dm/Lw becomes higher than the upper limit of inequality (13), the size of the entire optical system increases. In a case where Dm reduces so that Dm/Lw becomes lower than the lower limit of inequality (13), it is difficult to secure a sufficient base length.

The following inequality (14) may be satisfied:

$$0.05 \leq Dm / fm \leq 0.8 \qquad ( 14 )$$

where fm is a focal length of a subgroup GM disposed between the first reflective surface M1 and the second reflective surface M2 in the third lens unit L3 of each optical system.

In a case where Dm increases so that Dm/fm becomes higher than the upper limit of inequality (14), the size of the entire optical system increases. In a case where fm reduces so that Dm/fm becomes higher than the upper limit of inequality (14), it is difficult to correct coma. In a case where Dm reduces so that Dm/fm becomes lower than the lower limit of inequality (14), it is difficult to secure a sufficient base length. In a case where fm increases so that Dm/fm becomes lower than the lower limit of inequality (14), the effective diameter of the second reflective surface M2 increases.

Each optical system may satisfy the following inequality (15):

$$1.7 \leq D 3 / D 1 \leq 10. \qquad ( 15 )$$

where D1 is a length (thickness) on the optical axis from a surface closest to the object to a surface closest to the image of the first lens unit L1, and D3 is a thickness on the optical axis from a surface closest to the object to a surface closest to the image of the third lens unit L3.

In a case where D3 increases so that D3/D1 becomes higher than the upper limit of inequality (15), the size of the entire optical system increases. In a case where D3 reduces so that D3/D1 becomes lower than the lower limit of inequality (15), it becomes difficult to secure a sufficient base length.

Each optical system may satisfy the following inequality (16):

$$0.9 \leq Dm / D 1 \leq 5. \qquad ( 16 )$$

In a case where Dm increases so that Dm/D1 becomes higher than the upper limit of inequality (16), the size of the entire optical system increases. In a case where Dm reduces so that Dm/D1 becomes lower than the lower limit of inequality (16), it becomes difficult to secure a sufficient base length.

Each optical system may satisfy the following inequality (17):

$$0.35 \leq D 2 / D 1 \leq 2.50 \qquad ( 17 )$$

where D2 is a thickness on the optical axis from an object-side surface of the second lens unit L2 to a surface closest to the image plane of the second lens unit L2 in each optical system.

In a case where D2 increases so that D2/D1 becomes higher than the upper limit of inequality (17), the size of the entire optical system increases. In a case where D2 reduces so that D2/D1 becomes lower than the lower limit of inequality (17), it becomes difficult to secure a sufficient magnification varying ratio. Each optical system may satisfy the following inequality (18):

$$0.3 \leq dp 1 / Dm \leq 0.90 \qquad ( 18 )$$

where dp1 is a distance on the optical axis between the first reflective surface M1 and the aperture stop SP.

In a case where dp1 increases so that dp1/Dm becomes higher than the upper limit of inequality (18), the effective diameter of the first lens unit L1 or the effective diameter of the first reflective surface M1 increases. In a case where dp1 reduces so that dp1/Dm becomes lower than the lower limit of inequality (18), interference between the first reflective surface M1 and the aperture stop SP may occur.

Each optical system may satisfy the following inequality (19):

$$0.9 \leq f 3 / Dm \leq 3.5 \qquad ( 19 )$$

where f3 is a focal length of the third lens unit L3.

In a case where f3 increases so that f3/Dm becomes higher than the upper limit of inequality (19), the effective diameter of the rear group LR increases. In a case where f3 reduces so that f3/Dm becomes lower than the lower limit of inequality (19), it becomes difficult to correct coma.

Each optical system may satisfy the following inequality (20):

$$0.05 \leq Dout / Din \leq 0.5 \qquad ( 20 )$$

where Din is a distance between the optical axes of the first lens units L1 (base length) and Dout is a distance between the optical axes of the rear groups LR.

In a case where Dout increases so that Dout/Din becomes higher than the upper limit of inequality (20), it is difficult to form image circles of two optical systems on a single image sensor. In a case where Din reduces so that Dout/Din becomes higher than the upper limit of inequality (20), it is difficult to secure a sufficient base length. In a case where Dout reduces so that Dout/Din becomes lower than the lower limit of inequality (20), interference between the rear groups LR may occur. In a case where Din increases so that Dout/Din becomes lower than the lower limit of inequality (20), the size of the entire optical system increases.

Inequalities (13) to (20) may be replaced with inequalities (13a) to (20a) below:

$$0.07 \leq Dm / Lw \leq 0 \text{.40} \qquad ( 13 a )$$

$$0.07 \leq Dm / fm \leq 0. 70 \qquad ( 14 a )$$

$$1.8 \leq D 3 / D 1 \leq 8.5 \qquad ( 15 a )$$

$$1. \leq Dm / D 1 \leq 4. \qquad ( 16 a )$$

$$0.38 \leq D 2 / D 1 \leq 2.20 \qquad ( 17 a )$$

$$0.4 \leq dp 1 / Dm \leq 0. 80 \qquad ( 18 a )$$

$$1. \leq f 3 / Dm \leq 3.2 \qquad ( 19 a )$$

$$0.08 \leq Dout / Din \leq 0.45 \qquad ( 20 a )$$

Inequalities (13) to (20) may be replaced with inequalities (13b) to (20b) below:

$$0.09 \leq Dm / Lw \leq 0 \text{.30} \qquad ( 13 b )$$

$$0.09 \leq Dm / fm \leq 0.6 \qquad ( 14 b )$$

$$1.9 \leq D 3 / D 1 \leq 7. \qquad ( 15 b )$$

$$1.1 \leq Dm / D 1 \leq 3.5 \qquad ( 16 b )$$

$$0.41 \leq D 2 / D 1 \leq 1.9 \qquad ( 17 b )$$

$$0.5 \leq dp 1 / Dm \leq 0. 75 \qquad ( 18 b )$$

$$1.1 \leq f 3 / Dm \leq 2.9 \qquad ( 19 b )$$

$$0.11 \leq Dout / Din \leq 0.4 \qquad ( 20 b )$$

A specific description will now be given of the optical systems in Examples 7 to 10 and their corresponding numerical examples 7 to 10.

### Example 7

The optical system according to Example 7 (numerical example 7) illustrated in FIG. 9 is a zoom optical system with an aperture ratio of about 4.0 and a half angle of view of about 39.0° at a wide-angle end, and an aperture ratio of about 4.0 and a half angle of view of about 17.2° at a telephoto end.

The optical system according to each of Examples 7 to 10 includes, in order from the object side to the image side, a first lens unit L1 having positive refractive power, a second lens unit L2 having negative refractive power, a third lens unit L3 having positive refractive power, a fourth lens unit L4 having positive refractive power, and a fifth lens unit L5 having negative refractive power. During magnification variation, the first lens unit L1, the third lens unit L3, and the fifth lens unit L5 do not move, and during magnification variation from the wide-angle end to the telephoto end, the second lens unit L2 moves toward the image side and the fourth lens unit L4 moves toward the object side, as illustrated by diagonal arrows in FIG. 9. During focusing from an object at infinity to an object at a close distance, the fourth lens unit L4 moves toward the object side, as indicated by a horizontal arrow in FIG. 9.

The third lens unit L3 includes a first reflective surface M1 and a second reflective surface M2, and an aperture stop SP is disposed between the first reflective surface M1 and the second reflective surface M2. A subgroup GM including a cemented lens in which a negative lens and a positive lens are cemented together is disposed between the first reflective surface M1 and the aperture stop SP (second reflective surface M2) in the third lens unit L3.

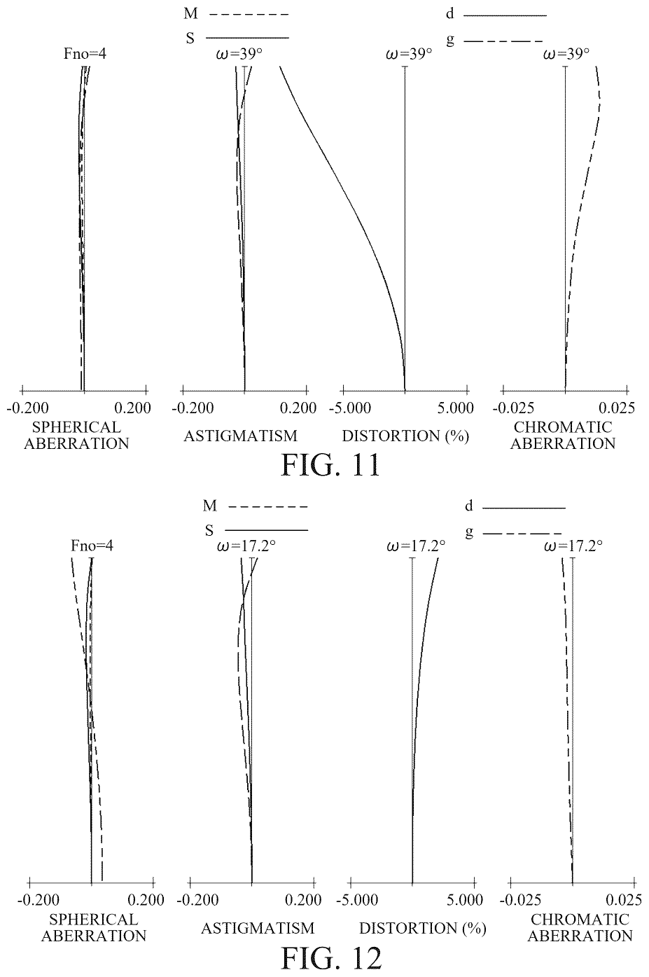

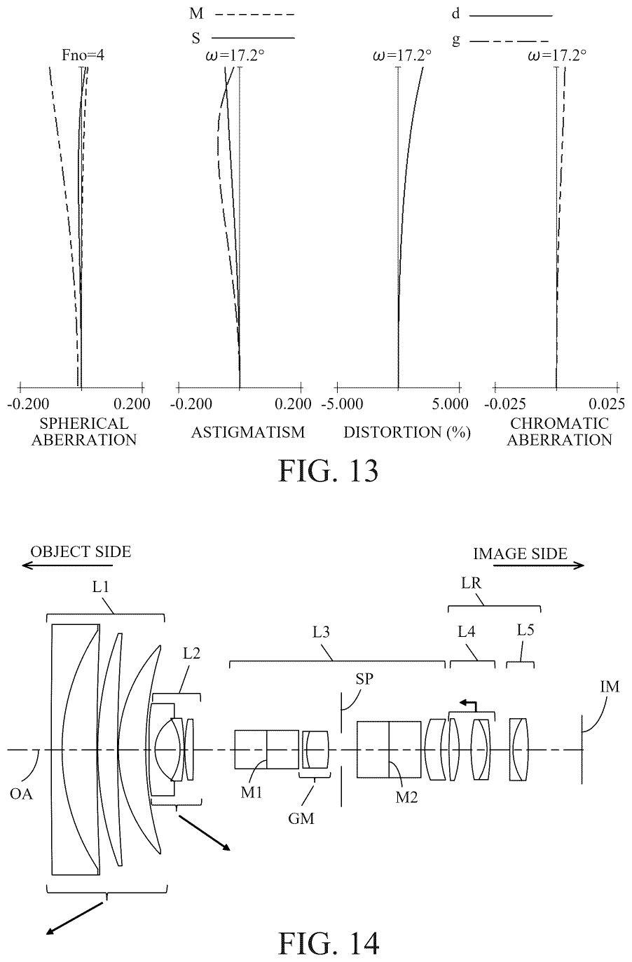

FIGS. 10 and 11 respectively illustrate longitudinal aberrations (spherical aberration, astigmatism, distortion, and chromatic aberration) of the optical system according to numerical example 7 at the wide-angle end in an in-focus state at infinity and in an in-focus state at a close distance. FIGS. 12 and 13 illustrate longitudinal aberrations of the optical system according to Example 7 at the telephoto end in an in-focus state at infinity and in an in-focus state at a close distance, respectively.

### Example 8

The optical system according to Example 8 (numerical example 8) illustrated in FIG. 14 is a zoom optical system with an aperture ratio of about 4.0 and a half angle of view of about 31.7° at a wide-angle end and an aperture ratio of about 4.0 and a half angle of view of about 14.3° at a telephoto end.

The optical system according to this example includes, in order from the object side to the image side, a first lens unit L1 having positive refractive power, a second lens unit L2 having negative refractive power, a third lens unit L3 having positive refractive power, a fourth lens unit L4 having positive refractive power, and a fifth lens unit L5 having negative refractive power. During magnification variation, the third lens unit L3, the fourth lens unit L4, and the fifth lens unit L5 do not move, and during magnification variation from the wide-angle end to the telephoto end, the first lens unit L1 moves toward the object side, and the second lens unit L2 moves toward the image side. During focusing from an object at infinity to an object at a close distance, the fourth lens unit L4 moves toward the object side.

The third lens unit L3 has a first reflective surface M1 and a second reflective surface M2, and an aperture stop SP is disposed between the first reflective surface M1 and the second reflective surface M2. A subgroup GM formed of a cemented lens in which a negative lens and a positive lens are cemented together is disposed between the first reflective surface M1 and the aperture stop SP (second reflective surface M2) in the third lens unit L3.

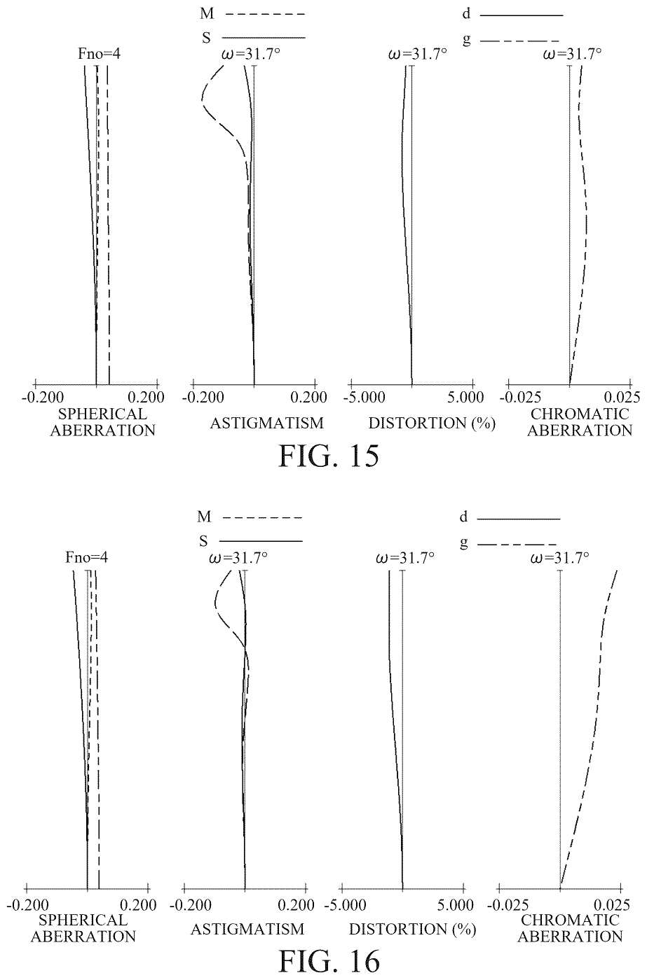

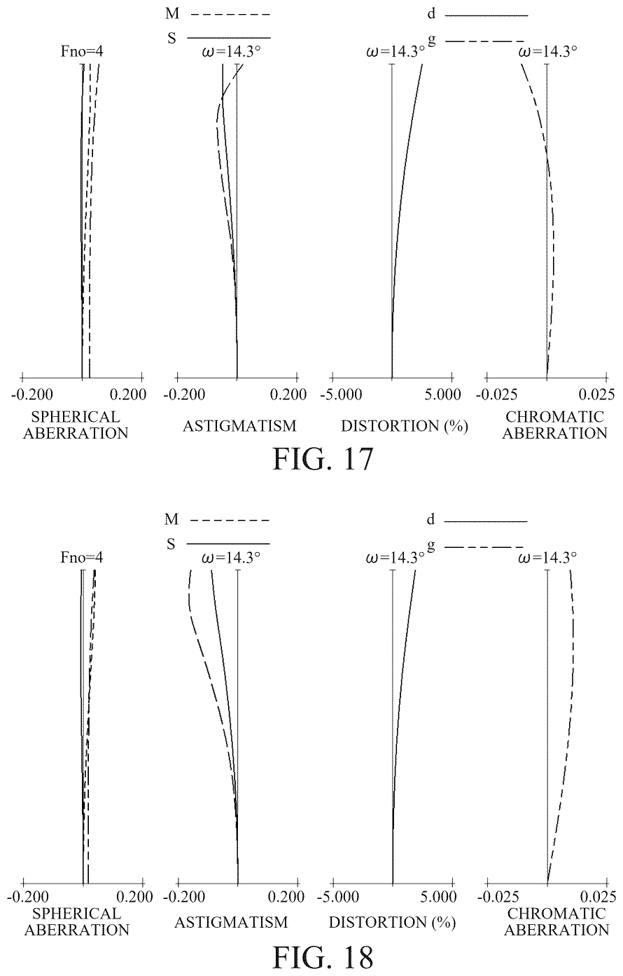

FIGS. 15 and 16 respectively illustrate longitudinal aberrations of the optical system according to numerical example 8 at the wide-angle end in the in-focus state at infinity and in the in-focus state at a close distance. FIGS. 17 and 18 respectively illustrate the longitudinal aberration of the optical system according to numerical example 8 at the telephoto end in an in-focus state at infinity and in an in-focus state at a close distance.

### Example 9

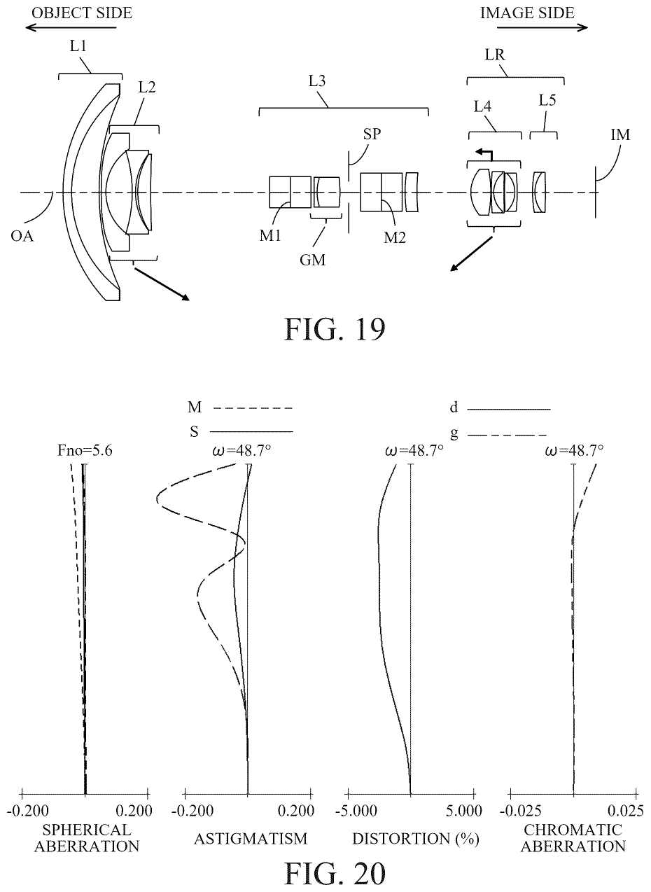

The optical system according to Example 9 (numerical example 9) illustrated in FIG. 19 is a zoom optical system with an aperture ratio of about 5.6 and a half angle of view of about 48.7° at a wide-angle end and an aperture ratio of about 5.6 and a half angle of view of about 19.8° at a telephoto end.

The optical system according to this example includes, in order from the object side to the image side, a first lens unit L1 having positive refractive power, a second lens unit L2 having negative refractive power, a third lens unit L3 having positive refractive power, a fourth lens unit L4 having positive refractive power, and a fifth lens unit L5 having negative refractive power. During magnification variation, the first lens unit L1, the third lens unit L3, and the fifth lens unit L5 do not move, and during magnification variation from the wide-angle end to the telephoto end, the second lens unit L2 moves toward the image side, and the fourth lens unit L4 moves toward the object side. During focusing from an object at infinity to an object at a close distance, the fourth lens unit L4 moves toward the object side.

The third lens unit L3 has a first reflective surface M1 and a second reflective surface M2, and an aperture stop SP is disposed between the first reflective surface M1 and the second reflective surface M2. A subgroup GM formed of a cemented lens in which a negative lens and a positive lens are cemented together is disposed between the first reflective surface M1 and the aperture stop SP (second reflective surface M2) in the third lens unit L3.

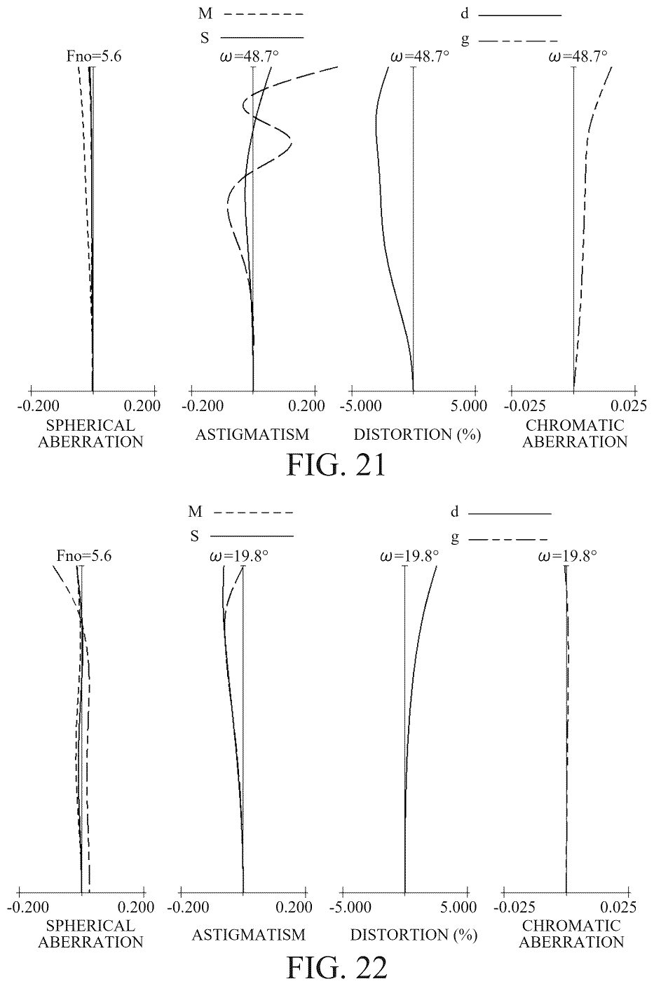

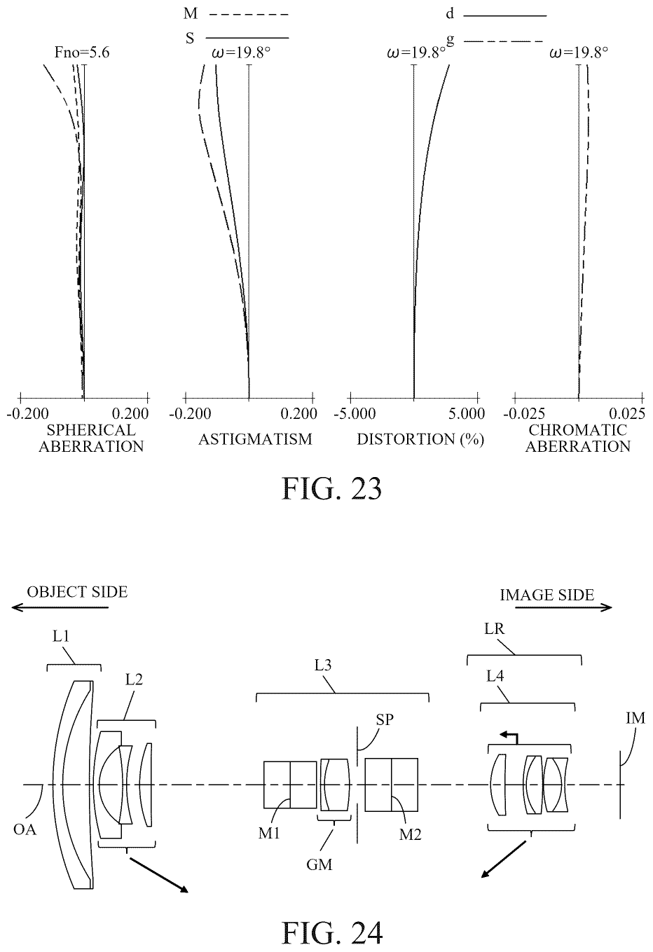

FIGS. 20 and 21 respectively illustrate longitudinal aberrations of the optical system according to numerical example 9 at the wide-angle end and in the in-focus state at infinity and in an in-focus state at a close distance. FIGS. 22 and 23 respectively illustrate longitudinal aberrations of the optical system according to numerical example 9 at the telephoto end in an in-focus state at infinity and in an in-focus state at a close distance.

### Example 10

The optical system according to Example 10 (numerical example 10) illustrated in FIG. 24 is a zoom optical system with an aperture ratio of about 4.0 and a half angle of view of about 34.8° at a wide-angle end and an aperture ratio of about 4.0 and a half angle of view of about 17.2° at a telephoto end.

The optical system according to this example includes, in order from the object side to the image side, a first lens unit L1 having positive refractive power, a second lens unit L2 having negative refractive power, a third lens unit L3 having positive refractive power, and a fourth lens unit L4 having positive refractive power. The first lens unit L1 and the third lens unit L3 do not move during magnification variation, and the second lens unit L2 moves to the image side and the fourth lens unit L4 moves to the object side during magnification variation from the wide-angle end to the telephoto end. During focusing from an object at infinity to an object at a close distance, the fourth lens unit L4 moves toward the object side.

The third lens unit L3 has a first reflective surface M1 and a second reflective surface M2, and an aperture stop SP is disposed between the first reflective surface M1 and the second reflective surface M2. A subgroup GM formed of a cemented lens in which a negative lens and a positive lens are cemented together is disposed between the first reflective surface M1 and the aperture stop SP (second reflective surface M2) in the third lens unit L3.

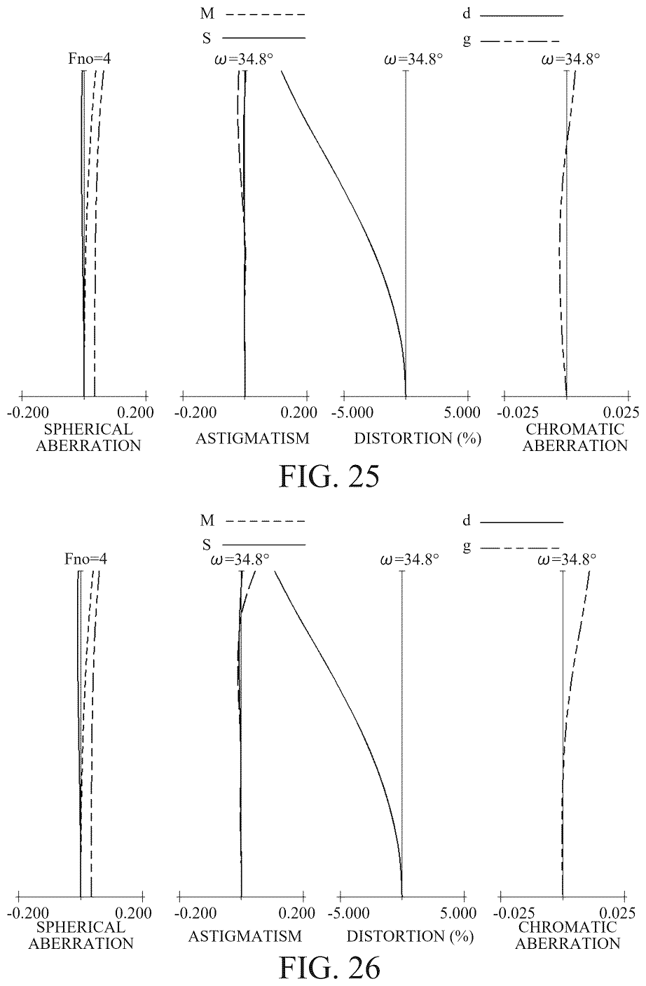

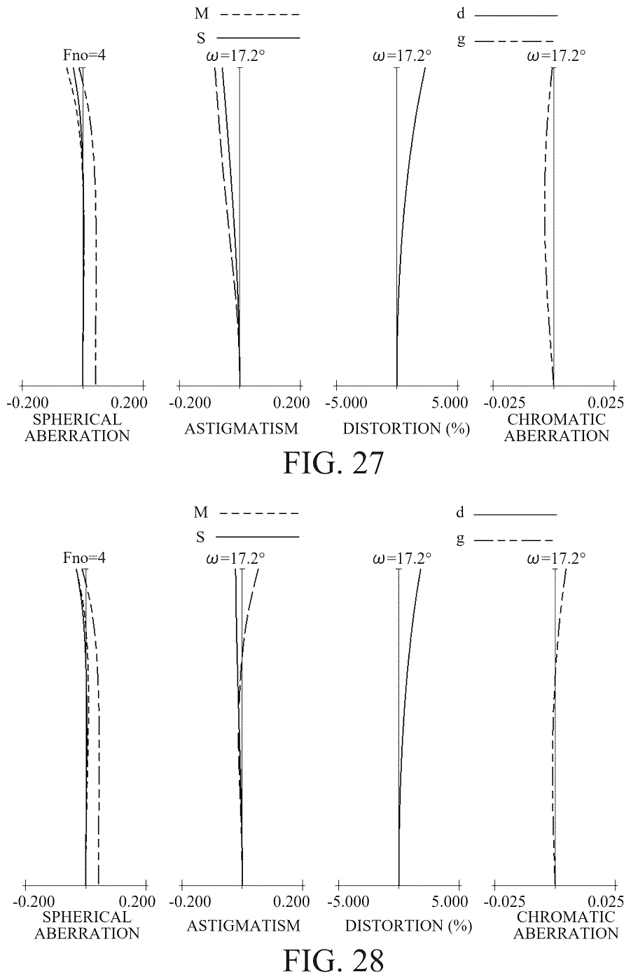

FIGS. 25 and 26 respectively illustrate longitudinal aberrations of the optical system according to numerical example 10 at the wide-angle end in an in-focus state at infinity and in an in-focus state at a close distance. FIGS. 27 and 28 respectively illustrate longitudinal aberrations of the optical system according to numerical example 10 at the telephoto end and in the in-focus state at infinity and in an in-focus state at a close distance.

Numerical examples 7 to 10 will now be illustrated below. For numerical examples 7 to 9, the base line length is set to 80 mm, and for numerical example 10, the base line length is set to 70 mm. A description of the symbols in each numerical example is similar to that of numerical examples 1 to 6.

At the end of each numerical example, a moving amount of the focus lens unit (fourth lens unit L4) at the wide-angle end from the in-focus state at infinity to the in-focus state at a close distance, and a moving amount of the focus lens unit at the telephoto end from the in-focus state at infinity to the in-focus state at a close distance are illustrated. A moving amount of the focus lens unit is a difference between the position of the focus lens unit in the in-focus state at infinity and the position of the focus lens unit at the telephoto end, and is considered positive in a case where the focus lens unit is located closer to the image plane in an in-focus state at a close distance than in an in-focus state at infinity.

Table 2 summarizes values corresponding to inequalities (12) to (20) in numerical examples 7 to 10. Each numerical example satisfies all inequalities (12) to (20).

### Numerical Example 7

UNIT: mm
SURFACE DATA

| Surface No. | r | d | nd | νd |
|---|---|---|---|---|
| 1 | 288.733 | 2.70 | 1.80810 | 22.8 |
| 2 | 83.557 | 6.28 | 1.72916 | 54.7 |
| 3 | −1363.692 | 0.13 | | |
| 4 | 40.455 | 3.98 | 1.85838 | 42.4 |
| 5 | 65.589 | (Variable) | | |
| 6 | 53.435 | 1.50 | 2.00100 | 29.1 |
| 7 | 11.444 | 4.93 | | |
| 8 | −109.225 | 1.00 | 1.88300 | 40.8 |
| 9 | 29.873 | 3.06 | | |
| 10 | −47.855 | 1.00 | 1.88300 | 40.8 |
| 11 | −124.802 | 0.20 | | |
| 12 | 30.283 | 3.08 | 1.80810 | 22.8 |
| 13 | −165.831 | (Variable) | | |
| 14 | ∞ | 8.00 | 1.60311 | 60.6 |
| 15 | ∞ | 8.00 | 1.60311 | 60.6 |
| 16 | ∞ | 1.00 | | |
| 17 | 163.860 | 1.00 | 1.77580 | 49.0 |
| 18 | 12.803 | 5.75 | 1.72916 | 54.7 |
| 19 | −48.936 | 3.00 | | |
| 20 (SP) | ∞ | 4.00 | | |
| 21 | ∞ | 8.00 | 1.60311 | 60.6 |
| 22 | ∞ | 8.00 | 1.60311 | 60.6 |
| 23 | ∞ | 1.00 | | |
| 24 | 15.958 | 4.00 | 2.00100 | 29.1 |
| 25 | 13.937 | (Variable) | | |
| 26 | 15.396 | 3.01 | 1.49700 | 81.5 |
| 27 | −500.909 | 0.20 | | |
| 28 | 46.329 | 0.80 | 2.00100 | 29.1 |
| 29 | 13.934 | 3.62 | 1.49700 | 81.5 |
| 30 | −41.238 | 0.20 | | |
| 31 | 17.677 | 4.24 | 1.69895 | 30.1 |
| 32 | −15.252 | 0.79 | 1.86769 | 41.8 |
| 33 | 20.913 | (Variable) | | |
| 34 | 26.682 | 0.80 | 2.00100 | 29.1 |
| 35 | 12.126 | 3.49 | 1.49700 | 81.5 |
| 36 | 3125.864 | 13.50 | | |
| Image Plane | ∞ | | | |

VARIOUS DATA
ZOOM RATIO 2.92

| | WIDE | MIDDLE | TELE |
|---|---|---|---|
| Focal Length | 9.49 | 14.56 | 27.66 |
| Fno | 4.00 | 4.00 | 4.00 |
| Half Angle of View(°) | 39.05 | 30.43 | 17.17 |
| Overall Lens Length | 159.15 | 159.15 | 159.15 |
| BF | 13.50 | 13.50 | 13.50 |
| d5 | 0.70 | 13.14 | 25.58 |
| d13 | 26.88 | 14.44 | 2.00 |
| d25 | 16.24 | 11.46 | 2.31 |
| d33 | 5.07 | 9.85 | 19.00 |

LENS UNIT DATA

| Lens Unit | Starting Surface | Focal Length |
|---|---|---|
| 1 | 1 | 90.24 |
| 2 | 6 | −12.67 |
| 3 | 14 | 55.16 |
| 4 | 26 | 34.30 |
| 5 | 34 | −279.18 |

| | |
|---|---|
| First Reflective Surface M1 | 15 |
| Second Reflective Surface M2 | 22 |

FOCUS LENS UNIT

| | |
|---|---|
| Starting Surface | 26 |
| Ending Surface | 33 |

| | |
|---|---|
| Moving Amount of Focus Lens Unit at Wide-Angle | −0.23 (mm) |
| End to In-Focus State at Close Distance (−0.5 m) | |
| Moving Amount of Focus Lens Unit at Wide-Angle | −0.91 (mm) |
| End to In-Focus State at Close Distance (−1.0 m) | |

### Numerical Example 8

UNIT: mm
SURFACE DATA

| Surface No. | r | d | nd | νd |
|---|---|---|---|---|
| 1 | 2607.354 | 2.70 | 1.80810 | 22.8 |
| 2 | 53.754 | 8.78 | 1.60311 | 60.6 |
| 3 | 638.030 | 0.20 | | |
| 4 | 83.680 | 5.00 | 1.83481 | 42.7 |
| 5 | 377.126 | 0.20 | | |
| 6 | 37.634 | 6.87 | 1.88148 | 40.5 |
| 7 | 85.603 | (Variable) | | |
| 8* | −437.903 | 1.50 | 1.59201 | 67.0 |
| 9 | 8.841 | 6.30 | | |
| 10 | −14.111 | 1.00 | 1.48749 | 70.2 |
| 11 | −51.597 | 0.20 | | |
| 12 | 38.160 | 2.11 | 1.80810 | 22.8 |
| 13 | −571.101 | (Variable) | | |
| 14 | ∞ | 8.00 | 1.60311 | 60.6 |
| 15 | ∞ | 8.00 | 1.60311 | 60.6 |
| 16 | ∞ | 1.00 | | |
| 17 | 241.799 | 1.00 | 1.90984 | 37.4 |
| 18 | 13.972 | 5.53 | 1.72916 | 54.7 |
| 19 | −30.309 | 3.22 | | |
| 20 (SP) | ∞ | 4.00 | | |
| 21 | ∞ | 8.00 | 1.60311 | 60.6 |
| 22 | ∞ | 8.00 | 1.60311 | 60.6 |
| 23 | ∞ | 1.00 | | |
| 24 | 20.935 | 4.00 | 2.00100 | 29.1 |
| 25 | 23.685 | (Variable) | | |
| 26 | 88.819 | 2.55 | 1.60311 | 60.6 |
| 27 | −24.461 | 2.98 | | |
| 28 | 35.507 | 4.02 | 1.48749 | 70.2 |
| 29 | −14.467 | 0.79 | 2.00096 | 28.3 |
| 30 | −56.140 | (Variable) | | |
| 31 | −5132.513 | 0.80 | 1.77250 | 49.6 |
| 32 | 14.179 | 3.86 | 1.49700 | 81.5 |
| 33 | −49.224 | 13.50 | | |
| Image Plane | ∞ | | | |

ASPHERIC DATA
8th Surface
K = 0.00000e+00 A 4 = 7.25708e−05 A 6 = −3.54113e−07 A 8 = 1.63113e−09
A10 = −3.97443e−12

VARIOUS DATA
ZOOM RATIO 2.43

| | WIDE | MIDDLE | TELE |
|---|---|---|---|
| Focal Length | 13.86 | 14.85 | 33.58 |
| Fno | 4.00 | 4.00 | 4.00 |
| Half Angle of View(°) | 31.67 | 29.94 | 14.28 |
| Overall Lens Length | 133.49 | 135.40 | 145.62 |
| BF | 13.50 | 13.50 | 13.50 |
| d7 | 0.84 | 3.17 | 21.50 |
| d13 | 10.53 | 10.10 | 2.00 |
| d25 | 2.09 | 2.09 | 2.09 |
| d30 | 4.93 | 4.93 | 4.93 |

LENS UNIT DATA

| Lens Unit | Starting Surface | Focal Length |
|---|---|---|
| 1 | 1 | 56.60 |
| 2 | 8 | −14.52 |
| 3 | 14 | 41.63 |
| 4 | 26 | 33.76 |
| 5 | 31 | −111.41 |

| | |
|---|---|
| First Reflective Surface M1 | 15 |
| Second Reflective Surface M2 | 22 |

FOCUS LENS UNIT

| | |
|---|---|
| Starting Surface | 26 |
| Ending Surface | 30 |

| | |
|---|---|
| Moving Amount of Focus Lens Unit at Wide-Angle | −0.37 (mm) |
| End to In-Focus State at Close Distance (−0.5 m) | |
| Moving Amount of Focus Lens Unit at Wide-Angle | −0.59 (mm) |
| End to In-Focus State at Close Distance (−1.5 m) | |

### Numerical Example 9

UNIT: mm
SURFACE DATA

| Surface No. | r | d | nd | νd |
|---|---|---|---|---|
| 1 | 52.704 | 2.90 | 1.80810 | 22.8 |
| 2 | 41.136 | 9.27 | 1.72916 | 54.7 |
| 3 | 78.200 | (Variable) | | |
| 4* | 122.204 | 1.60 | 1.85400 | 40.4 |
| 5 | 17.266 | 8.90 | | |
| 6 | −45.084 | 1.10 | 1.88300 | 40.8 |
| 7 | 20.764 | 0.76 | | |
| 8 | 23.807 | 4.37 | 1.80810 | 22.8 |
| 9 | 295.963 | (Variable) | | |
| 10 | ∞ | 7.00 | 1.60311 | 60.6 |
| 11 | ∞ | 7.00 | 1.60311 | 60.6 |
| 12 | ∞ | 1.04 | | |
| 13 | −153.632 | 1.00 | 1.53269 | 66.6 |
| 14 | 14.946 | 7.71 | 1.48749 | 70.2 |
| 15 | −42.890 | 3.00 | | |
| 16 (SP) | ∞ | 4.00 | | |
| 17 | ∞ | 7.00 | 1.60311 | 60.6 |
| 18 | ∞ | 7.00 | 1.60311 | 60.6 |
| 19 | ∞ | 1.00 | | |
| 20 | 47.103 | 4.00 | 2.00100 | 29.1 |
| 21 | 69.505 | (Variable) | | |
| 22* | 10.955 | 6.74 | 1.49710 | 81.6 |
| 23 | −39.985 | 0.20 | | |
| 24 | 87.323 | 0.80 | 1.88300 | 40.8 |
| 25 | 8.324 | 3.45 | 1.49700 | 81.5 |
| 26 | 323.109 | 0.20 | | |
| 27 | 108.869 | 3.48 | 1.69895 | 30.1 |
| 28 | −8.755 | 0.79 | 1.89826 | 38.8 |
| 29 | −60.102 | (Variable) | | |
| 30 | 37.409 | 0.80 | 1.88300 | 40.8 |
| 31 | 10.416 | 3.53 | 1.49700 | 81.5 |
| 32 | −165.808 | 16.91 | | |
| Image Plane | ∞ | | | |

ASPHERIC DATA
4th Surface
K = 0.00000e+00 A 4 = 1.30577e−05 A 6 = 1.74397e−08 A 8 = −1.06744e−10
A10 = 1.75114e−13
22nd Surface
K = 0.00000e+00 A 4 = −3.57428e−05 A 6 = −3.03374e−07 A 8 = 1.95630e−10
A10 = −4.04960e−11

VARIOUS DATA
ZOOM RATIO 3.15

| | WIDE | MIDDLE | TELE |
|---|---|---|---|
| Focal Length | 7.52 | 11.61 | 23.71 |
| Fno | 5.60 | 5.60 | 5.60 |
| Half Angle of View(°) | 48.66 | 36.38 | 19.83 |
| Overall Lens Length | 179.72 | 179.72 | 179.72 |
| BF | 16.91 | 16.91 | 16.91 |
| d3 | 0.70 | 19.64 | 38.59 |
| d9 | 40.12 | 21.18 | 2.23 |
| d21 | 18.17 | 13.53 | 1.92 |
| d29 | 5.18 | 9.82 | 21.43 |

LENS UNIT DATA

| Lens Unit | Starting Surface | Focal Length |
|---|---|---|
| 1 | 1 | 198.46 |
| 2 | 4 | −12.14 |
| 3 | 10 | 80.01 |
| 4 | 22 | 37.84 |
| 5 | 30 | −99.77 |

| | |
|---|---|
| First Reflective Surface M1 | 11 |
| Second Reflective Surface M2 | 18 |

FOCUS LENS UNIT

| | |
|---|---|
| Starting Surface | 22 |
| Ending Surface | 29 |

| | |
|---|---|
| Moving Amount of Focus Lens Unit at Wide-Angle | −0.11 (mm) |
| End to In-Focus State at Close Distance (−0.5 m) | |
| Moving Amount of Focus Lens Unit at Wide-Angle | −0.52 (mm) |
| End to In-Focus State at Close Distance (−1.0 m) | |

### Numerical Example 10

UNIT: mm
SURFACE DATA

| Surface No. | r | d | nd | νd |
|---|---|---|---|---|
| 1 | 66.529 | 2.50 | 1.84666 | 23.8 |
| 2 | 44.459 | 6.78 | 1.72916 | 54.7 |
| 3 | 303.617 | (Variable) | | |
| 4 | 49.566 | 1.50 | 1.83481 | 42.7 |
| 5 | 11.682 | 5.98 | | |
| 6 | −50.450 | 1.00 | 1.72916 | 54.7 |
| 7 | 34.160 | 3.31 | | |
| 8 | 29.572 | 2.92 | 1.84666 | 23.8 |
| 9 | 558.484 | (Variable) | | |
| 10 | ∞ | 6.70 | 1.51633 | 64.1 |
| 11 | ∞ | 6.70 | 1.51633 | 64.1 |
| 12 | ∞ | 1.00 | | |
| 13 | 154.682 | 1.00 | 1.85123 | 37.8 |
| 14 | 17.252 | 6.35 | 1.72916 | 54.7 |
| 15 | −39.355 | 2.00 | | |
| 16 (SP) | ∞ | 2.00 | | |
| 17 | ∞ | 6.70 | 1.51633 | 64.1 |
| 18 | ∞ | 6.70 | 1.51633 | 64.1 |
| 19 | ∞ | (Variable) | | |
| 20 | 15.001 | 3.66 | 1.49700 | 81.5 |
| 21 | 169.042 | 4.62 | | |
| 22 | 26.128 | 0.80 | 1.90043 | 37.4 |
| 23 | 12.047 | 4.18 | 1.49700 | 81.5 |
| 24 | −65.731 | 0.20 | | |
| 25 | 24.487 | 4.61 | 1.59270 | 35.3 |
| 26 | −10.743 | 0.79 | 1.88697 | 40.2 |
| 27 | 27.201 | (Variable) | | |
| Image Plane | ∞ | | | |

VARIOUS DATA
ZOOM RATIO 2.50

| | WIDE | MIDDLE | TELE |
|---|---|---|---|
| Focal Length | 11.07 | 16.30 | 27.66 |
| Fno | 4.00 | 4.00 | 4.00 |
| Half Angle of View(°) | 34.81 | 27.67 | 17.18 |
| Overall Lens Length | 144.46 | 144.46 | 144.46 |
| BF | 14.14 | 18.12 | 25.24 |
| d3 | 1.01 | 14.35 | 27.68 |
| d9 | 28.75 | 15.41 | 2.08 |
| d19 | 18.56 | 14.57 | 7.45 |
| d27 | 14.14 | 18.12 | 25.24 |

LENS UNIT DATA

| Lens Unit | Starting Surface | Focal Length |
|---|---|---|
| 1 | 1 | 127.16 |
| 2 | 4 | −17.93 |
| 3 | 10 | 58.73 |
| 4 | 20 | 43.07 |

| | |
|---|---|
| First Reflective Surface M1 | 11 |
| Second Reflective Surface M2 | 18 |

FOCUS LENS UNIT

| | |
|---|---|
| Starting Surface | 20 |
| Ending Surface | 27 |

| | |
|---|---|
| Moving Amount of Focus Lens Unit at Wide-Angle | −0.33 (mm) |
| End to In-Focus State at Close Distance (−0.5 m) | |
| Moving Amount of Focus Lens Unit at Wide-Angle | −0.85 (mm) |
| End to In-Focus State at Close Distance (−1.0 m) | |

TABLE 2

| | | Inequality | | | | | | | | |
|---|---|---|---|---|---|---|---|---|---|---|
| | | (12) | (13) | (14) | (15) | (16) | (17) | (18) | (19) | (20) |
| Numerical | 7 | 9.513 | 0.193 | 0.489 | 3.952 | 2.348 | 1.128 | 0.610 | 1.794 | 0.231 |
| Example | 8 | 4.083 | 0.230 | 0.479 | 2.179 | 1.295 | 0.468 | 0.610 | 1.354 | 0.231 |
| | 9 | 26.380 | 0.171 | 0.162 | 4.088 | 2.527 | 1.375 | 0.642 | 2.602 | 0.231 |
| | 10 | 11.490 | 0.198 | 0.438 | 4.218 | 2.774 | 1.585 | 0.662 | 2.281 | 0.264 |

### Image Pickup Apparatus

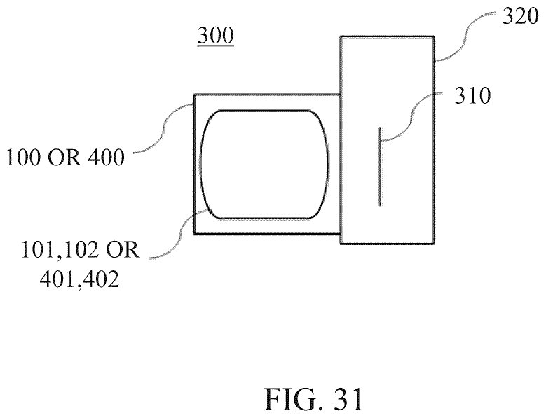

FIG. 31 illustrates an image pickup apparatus 300 including a stereoscopic optical system 100 or 400 according to any one of Examples 1 to 10. The image pickup apparatus 300 includes a camera body 320 and a lens apparatus having the stereoscopic optical system 100 or 400 according to any one of Examples 1 to 10. The camera body 320 includes an image sensor 310 such as a CCD sensor or a CMOS sensor that photoelectrically converts two optical images formed by the stereoscopic optical system 100 or 400 (i.e., images an object).

The lens apparatus may be attachable to and detachable from the camera body 320 or may be integrated with the camera body 320. The camera body 320 may be a single-lens reflex camera with a quick-turn mirror, or a mirrorless camera without a quick-turn mirror.

The image pickup apparatus 300 having the stereoscopic optical system 100 or 400 according to each example can provide a high-quality captured image (pair of parallax images) that allows good stereoscopic viewing.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a stereoscopic optical system that includes two optical systems capable of magnification variation, configured to bend an optical path, and arranged in parallel, and has a sufficient magnification varying ratio and high optical performance.

This application claims priority to Japanese Patent Application Nos. 2024-000756 and 2024-000777, each of which was filed on Jan. 5, 2024, and each of which is hereby incorporated by reference herein in their entirety.

What is claimed is:

1. A stereoscopic optical system comprising:
two optical systems configured to perform magnification variation and arranged in parallel,
wherein each of the two optical systems includes, in order from an object side to an image side, a first lens unit having positive refractive power, a second lens unit having negative refractive power, a third lens unit, and a rear group including a fourth lens unit and having positive refractive power as a whole,
wherein a distance between adjacent lens units changes during magnification variation,
wherein the third lens unit includes a first reflective surface, a second reflective surface, and an aperture stop, and a distance between optical axes between rear groups in the two optical systems is narrower than a distance between optical axes of the first lens units in the two optical systems due to bending of an optical path by the first reflective surface and the second reflective surface, and
wherein the following inequality is satisfied:
$$0.16 \leq \vert m 4 / f 4 \vert \leq 1.28$$
where m4 is a moving amount of the fourth lens unit during magnification variation from a wide-angle end to a telephoto end, and f4 is a focal length of the fourth lens unit.

2. The stereoscopic optical system according to claim 1, wherein the following inequality is satisfied:
$$0.01 \leq \vert Z 2 / Z 4 \vert \leq 2.26$$
where β2w and β4w are imaging magnifications of the second lens unit and the fourth lens unit, respectively, at the wide-angle end in an in-focus state on an object at infinity, and β2t and β4t are imaging magnifications of the second lens unit and the fourth lens unit, respectively, at the telephoto end in an in-focus state on an object at infinity, respectively, and
$$Z 2 = β 2 t / β 2 w$$
$$Z 4 = β 4 t / β 4 w .$$

3. The stereoscopic optical system according to claim 1, wherein the following inequality is satisfied:
$$0.01 \leq Dout / Din \leq 0.74$$
where Din is the distance between the optical axes of first lens units in the two optical systems, and Dout is the distance between the optical axes of the rear groups in the two optical systems.

4. The stereoscopic optical system according to claim 1, wherein the aperture stop is disposed between the first reflective surface and the second reflective surface in the third lens unit.

5. The stereoscopic optical system according to claim 1, wherein the following inequality is satisfied:
$$0.79 \leq dG 1 SP / dSPI \leq 1.5$$
where dG1SP is a distance on the optical axis from an object-side surface of a lens closest to the object in the first lens unit at the wide-angle end to the aperture stop, and dSPI is a distance on the optical axis from the aperture stop to an image plane at the wide-angle end.

6. The stereoscopic optical system according to claim 1, wherein the following inequality is satisfied:
$$4.28 \leq dG 1 SP / fw \leq 11.32$$
where dG1SP is a distance on the optical axis from an object-side surface of a lens closest to the object in the first lens unit at the wide-angle end to the aperture stop, and fw is a focal length of each of the two optical systems at the wide-angle end.

7. The stereoscopic optical system according to claim 1, wherein the following inequality is satisfied:
$$5.28 \leq dSPI / fw \leq 19.09$$
where dSPI is a distance on the optical axis from the aperture stop to an image plane at the wide-angle end, and fw is a focal length of each of the two optical systems at the wide-angle end.

8. The stereoscopic optical system according to claim 1, wherein the following inequality is satisfied:
$$9.55 \leq Lw / fw \leq 19.09$$
where Lw is a distance on the optical axis from an object-side surface of a lens closest to the object in the first lens unit at the wide-angle end to an image plane, and fw is a focal length of each of the two optical systems at the wide-angle end.

9. The stereoscopic optical system according to claim 1, wherein the third lens unit has positive refractive power.

10. The stereoscopic optical system according to claim 1, wherein the following inequality is satisfied:
$$3. 43 \leq f 3 / fw \leq 8.46$$
where f3 is a focal length of the third lens unit, and fw is a focal length of each of the two optical systems at the wide-angle end.

11. The stereoscopic optical system according to claim 1, wherein the following inequality is satisfied:
$$5.42 \leq f 1 / fw \leq 17.20$$
where f1 is a focal length of the first lens unit, and fw is a focal length of each of the two optical systems at the wide-angle end.

12. The stereoscopic optical system according to claim 1, wherein the following inequality is satisfied:
$$- 12.61 \leq f 1 / f 2 \leq - 4.91$$
where f1 is a focal length of the first lens unit, and f2 is a focal length of the second lens unit.

13. The stereoscopic optical system according to claim 1, wherein the following inequality is satisfied:
$$2.56 \leq f 4 w / fw \leq 6.75$$
where f4w is a focal length of the fourth lens unit at the wide-angle end, and fw is a focal length of each of the two optical systems at the wide-angle end.

14. A stereoscopic optical system comprising:
two optical systems configured to perform magnification variation and arranged in parallel,
wherein each of the two optical systems includes, in order from an object side to an image side, a first lens unit having positive refractive power, a second lens unit having negative refractive power, a third lens unit, and a rear group including at least one lens unit,
wherein a distance between adjacent lens units changes during magnification variation,
wherein the third lens unit has a first reflective surface and a second reflective surface, and a distance between optical axes between rear groups in the two optical systems is narrower than a distance between optical axes of the first lens units in the two optical systems due to bending of an optical path by the first reflective surface and the second reflective surface,
wherein in each of the two optical systems, at least the second lens unit moves during magnification variation, and
wherein the following inequality is satisfied:
$$3. 5 \leq f 1 / fw \leq 32.0$$
where fw is a focal length of each of the two optical systems at a wide-angle end, and f1 is a focal length of the first lens unit.

15. The stereoscopic optical system according to claim 14, wherein an aperture stop is disposed between the first reflective surface and the second reflective surface in the third lens unit.

16. The stereoscopic optical system according to claim 14, wherein the following inequality is satisfied:
$$0.05 \leq Dm / Lw \leq 0.50$$
where Dm is a distance on the optical axis between the first reflective surface and the second reflective surface, and Lw is an overall optical length of each of the two optical systems at the wide-angle end.

17. The stereoscopic optical system according to claim 14, wherein the following inequality is satisfied:
$$0.05 \leq Dm / fm \leq 0.80$$
where Dm is a distance on the optical axis between the first reflective surface and the second reflective surface, and fm is a focal length of a subgroup disposed between the first reflective surface and the second reflective surface in the third lens unit.

18. The stereoscopic optical system according to claim 14, wherein the following inequality is satisfied:
$$1. 7 \leq D 3 / D 1 \leq 10.0$$
where D1 is a thickness on the optical axis from a surface closest to an object of the first lens unit to a surface closest to an image plane of the first lens unit, and D3 is a thickness on the optical axis from a surface closest to the object of the third lens unit to a surface closest to the image plane of the third lens unit.

19. A stereoscopic optical system according to claim 14, wherein the following inequality is satisfied:
$$0.9 \leq Dm / D 1 \leq 5.$$
where Dm is a distance on the optical axis between the first reflective surface and the second reflective surface, and D1 is a thickness on the optical axis from a surface closest to an object of the first lens unit to a surface closest to an image plane of the first lens unit.

20. The stereoscopic optical system according to claim 14, wherein the following inequality is satisfied:
$$0.35 \leq D 2 / D 1 \leq 2.50$$
where D1 is a thickness on the optical axis from a surface closest to an object of the first lens unit to a surface closest to an image plane of the first lens unit, and D2 is a thickness on the optical axis from a surface closest to the object of the second lens unit to a surface closest to an image plane of the second lens unit.

21. The stereoscopic optical system according to claim 14, wherein the third lens unit includes an aperture stop, and
wherein the following inequality is satisfied:
$$0.3 \leq dp 1 / Dm \leq 0.90$$
where dp1 is a distance on the optical axis between the first reflective surface and the aperture stop, and Dm is a distance on the optical axis between the first reflective surface and the second reflective surface.

22. The stereoscopic optical system according to claim 14, wherein the following inequality is satisfied:
$$0.9 \leq f 3 / Dm \leq 3.5$$
where f3 is a focal length of the third lens unit L3, and Dm is a distance on the optical axis between the first reflective surface and the second reflective surface.

23. The stereoscopic optical system according to claim 14, wherein the following inequality is satisfied:
$$0.05 \leq D out / Din \leq 0.50$$
where Din is the distance between the optical axes between the first lens units in the two optical systems, and Dout is a distance between optical axes between the rear group in the two optical systems.

24. An image pickup apparatus comprising:
a stereoscopic optical system; and
an image sensor configured to image an object via the stereoscopic optical system,
wherein the stereoscopic optical system includes:
two optical systems configured to perform magnification variation and arranged in parallel,
wherein each of the two optical systems includes, in order from an object side to an image side, a first lens unit having positive refractive power, a second lens unit having negative refractive power, a third lens unit, and a rear group including a fourth lens unit and having positive refractive power as a whole,
wherein a distance between adjacent lens units changes during magnification variation,
wherein the third lens unit includes a first reflective surface, a second reflective surface, and an aperture stop, and a distance between optical axes between rear groups in the two optical systems is narrower than a distance between optical axes of the first lens units in the two optical systems due to bending of an optical path by the first reflective surface and the second reflective surface, and
wherein the following inequality is satisfied:
$$0.16 \leq \vert m 4 / f 4 \vert \leq 1.28$$
where m4 is a moving amount of the fourth lens unit during magnification variation from a wide-angle end to a telephoto end, and f4 is a focal length of the fourth lens unit.

25. An image pickup apparatus comprising:
a stereoscopic optical system; and
an image sensor configured to image an object via the stereoscopic optical system,
wherein the stereoscopic optical system includes:
two optical systems configured to perform magnification variation and arranged in parallel,
wherein each of the two optical systems includes, in order from an object side to an image side, a first lens unit having positive refractive power, a second lens unit having negative refractive power, a third lens unit, and a rear group including at least one lens unit,
wherein a distance between adjacent lens units changes during magnification variation,
wherein the third lens unit has a first reflective surface and a second reflective surface, and a distance between optical axes between rear groups in the two optical systems is narrower than a distance between optical axes of the first lens units in the two optical systems due to bending of an optical path by the first reflective surface and the second reflective surface,
wherein in each of the two optical systems, at least the second lens unit moves during magnification variation, and
wherein the following inequality is satisfied:
$$3. 5 \leq f 1 / fw \leq 32.0$$
where fw is a focal length of each of the two optical systems at a wide-angle end, and f1 is a focal length of the first lens unit.
